(19) United States
(12) Patent Application Publication
(10) Pub. No.: US 2026/0286651 A1
(43) Pub. Date: Sep. 24, 2026

(54) Automated Use Of Trained Predictive Dynamics Models For Autonomous Control Of Powered Earth-Moving Vehicles

(71) Applicant: AIM Intelligent Machines, Inc., Redmond, WA (US)

(72) Inventor: Thomas B. Wei, Seattle, WA (US)

(21) Appl. No.: 19/555,645

(22) Filed: Mar. 3, 2026

Related U.S. Application Data
(60) Provisional application No. 63/774,592, filed on Mar. 19, 2025.

(51) Int. Cl. E02F 9/20; G05D 1/246; G05D 1/617; G05D 107/90

(52) U.S. Cl. CPC E02F 9/2045; G05D 1/2465; G05D 1/617; G05D 2107/90

(57) ABSTRACT

Systems and techniques are described for implementing autonomous control of powered earth-moving vehicles, including to automatically control movement of a vehicle's component parts on a job site to perform tasks. The techniques may include using an MPC-based Control System to perform a training and deployment cycle for a predictive dynamics model specific to a particular earth-moving vehicle to control that vehicle's autonomous operations, and to further using resulting data in additional manners—such a cycle may include using a data gathering module on the vehicle to gather actual operational data of the vehicle during manual control of the vehicle on job site(s) by human operator(s) during performance of task(s), generating a 3D site map modeling the vehicle's surroundings, training a Model Predictive Control (MPC) model based on the actual operational data and 3D site map, and deploying the trained model to the vehicle for use in autonomous operations.

### CROSS REFERENCE TO RELATED APPLICATIONS

This application claims the benefit of U.S. Provisional Patent Application No. 63/774,592, filed Mar. 19, 2025 and entitled “Automated Use Of Trained Predictive Dynamics Models For Autonomous Control Of Powered Earth-Moving Vehicles,” which is hereby incorporated by reference in its entirety.

### TECHNICAL FIELD

The following disclosure relates generally to systems and techniques for autonomous control of powered earth-moving vehicles, such as to using a trained predictive dynamics model for controlling autonomous operations of a powered earth-moving mining and/or construction vehicle based on predicted changes to the vehicle and/or a surrounding environment resulting from determined vehicle action sequences involving inputs to the vehicle controls.

### BACKGROUND

Earth-moving construction vehicles (e.g., loaders, excavators, bulldozers, deep sea machinery, extra-terrestrial machinery, etc.) may be used on a job site to move soil and other materials (e.g., gravel, rocks, asphalt, etc.) and to perform other operations, and are each typically operated by a human operator (e.g., a human user present inside a cabin of the construction vehicle, a human user at a location separate from the construction vehicle but performing interactive remote control of the construction vehicle, etc.). Similarly, earth-moving mining vehicles may be used to extract or otherwise move soil and other materials (e.g., gravel, rocks, asphalt, etc.) and to perform other operations, and are each typically operated by a human operator (e.g., a human user present inside a cabin of the mining vehicle, a human user at a location separate from the mining vehicle but performing interactive remote control of the mining vehicle, etc.).

Limited fully autonomous operations (e.g., performed under automated programmatic control without human user interaction or intervention) of some construction and mining vehicles have occasionally been used, but existing techniques suffer from a number of problems, including the use of limited types of sensed data, an inability to perform fully autonomous operations when faced with on-site obstacles, an inability to coordinate autonomous operations between multiple on-site construction and/or mining vehicles, requirements for bulky and expensive hardware systems to support the limited autonomous operations, etc.

### BRIEF DESCRIPTION OF THE DRAWINGS

FIG. 1A is a network diagram illustrating an example embodiment of using described systems and techniques to determine and implement autonomous operations of one or more powered earth-moving vehicles of a common vehicle type on a site using data gathered by on-vehicle sensors and a trained predictive dynamics model for that type of powered earth-moving vehicle, including to perform automated operations that include controlling autonomous operations of a powered earth-moving mining and/or construction vehicle based on predicted changes to the vehicle and/or a surrounding environment resulting from determined vehicle action sequences involving inputs to the vehicle controls.

FIG. 1B is a diagram illustrating example components and interactions used to implement autonomous operations of one or more powered earth-moving vehicles on a site.

FIGS. 2A-2H illustrate examples of powered earth-moving construction and/or mining vehicles having an on-vehicle autonomous operations control system and multiple types of on-vehicle data sensors positioned to support autonomous operations on a site.

FIGS. 2I-2K illustrate examples of autonomous operations and associated data used for controlling movement of some or all of a powered earth-moving vehicle of a vehicle type using data gathered by on-vehicle sensors and a trained predictive dynamics model for that type of powered earth-moving vehicle, including to perform automated operations that include using a trained predictive dynamics model for controlling autonomous operations of a powered earth-moving mining and/or construction vehicle based on predicted changes to the vehicle and/or a surrounding environment resulting from determined vehicle action sequences involving inputs to the vehicle controls.

FIGS. 3A-3B are an example flow diagram of an illustrated embodiment of an MPC (Model Predictive Control)-Based Control System routine.

FIGS. 4A-4B are an example flow diagram of an illustrated embodiment of an EMVAOC Operations Planner And Implementation module routine.

FIG. 5 is an example flow diagram of an illustrated embodiment of an EMVAOC Action Determiner module routine.

### DETAILED DESCRIPTION

Systems and techniques are described for implementing autonomous control of operations of powered earth-moving vehicles (e.g., construction and/or mining vehicles) on a site using a trained predictive dynamics model, including to automatically control movement of movable vehicle component parts of one or more powered earth-moving vehicles on a job site to implement automated operations for performing tasks. In at least some embodiments, the techniques include using a trained model predictive control (MPC) vehicle behavior and environment dynamics model or other predictive dynamics model for a type of powered earth-moving vehicle (e.g., with particular tool attachments and/or other hardware configuration) to predict changes over time to a vehicle of that vehicle type and/or a surrounding environment that result from inputs to the vehicle's controls (e.g., to one or more joystick controls, pedal controls, button controls, switch controls, lever controls, etc., such as to turn, push, pull or otherwise move such vehicle controls)—the predicted changes over time to a vehicle state from a trained predictive dynamics model may include, for example, motion of the powered earth-moving vehicle (via movement of its tracks and/or wheels) and/or movement of its moveable component parts (e.g., a rotatable vehicle body including a cabin, such as for an excavator; one or more tool attachments, such as a digging bucket, claw, hammer, blade, etc.; one or more hydraulic arms that connect the vehicle body and the tool attachment(s); etc.), and predicted changes to the surrounding environment over time may include modifications to the terrain from the predicted vehicle motion and/or movements of the vehicle's component parts. The predictive machine learning (“ML”) dynamics model may be trained using data gathered on vehicles of the vehicle types during actual operations in performing tasks. In at least some embodiments and situations, an MPC-based Control System being executed on a powered earth-moving vehicle by the vehicle's computing device(s) may then use a copy of the trained MPC vehicle behavior and environment dynamics model (or other trained predictive dynamics model) on the powered earth-moving vehicle to implement autonomous operations of one or more types on the powered earth-moving vehicle in performing tasks of one or more types, such as for semi-autonomous and/or fully autonomous operations, and in some cases under control of an Earth-Moving Vehicle Autonomous Operations Control (EMVAOC) system that is part of the MPC-based Control System.

Such automated operations of the powered earth-moving vehicles may in at least some embodiments be implemented in accordance with specified safety configuration data, such as to prevent motion of a powered earth-moving vehicle (via movement of its tracks and/or wheels) and/or movement of its moveable component parts (e.g., a rotatable vehicle body including a cabin, such as for an excavator; a tool attachment, such as a digging bucket, claw, hammer, blade, etc.; one or more hydraulic arms; etc.) from entering positions in three-dimensional (“3D”) space that inhibit safe operations (e.g., positions that are already occupied by on-site obstacles or other portions of the powered earth-moving vehicle, such as the vehicle body, tracks or wheels; etc.; that cause a lack of balancing above a defined threshold; etc.), or that cause other specified safety-related constraints to be violated (e.g., by satisfying defined criteria corresponding to such constraints). Such specified safety operations may in some embodiments be encoded in the trained predictive dynamics model and implemented in automated vehicle operations determined from results of the trained predictive dynamics model, and in some embodiments may be implemented separately from automated vehicle operations determined from results of the trained predictive dynamics model, such as via safety checks performed while implementing such automated vehicle operations.

In at least some embodiments and situations, as part of using a trained MPC predictive vehicle behavior and environment dynamics model (also referred to herein as a “trained MPC predictive dynamics model”) (or other trained predictive dynamics model) to implement autonomous operations of a powered earth-moving vehicle, the EMVAOC system may receive information about a task to be performed on a site by the vehicle over a period of time (e.g., minutes or hours), such as from an automated planner module or other source. The received information about the task may include, for example, one or more target trajectories in 3D space for the vehicle body and/or one or more vehicle component parts. As one example, if the vehicle is a bulldozer with a front blade attachment and a rear ripper tool attachment, the one or more trajectories may include one or more first trajectories with 3D points over time each having a location and orientation of a distinct spot on the vehicle body (e.g., a spot at which vehicle position and/or orientation is measured, such as a spot at which a GPS sensor and/or inclinometer sensor is mounted), and/or one or more second trajectories each having 3D points over time for locations and orientations of one or more points on the blade tool attachment and/or on the hydraulic arms connecting the vehicle body and blade tool attachment (e.g., one or more spots at which position and/or orientation of the tool attachment or a hydraulic arm, respectively, is measured), and/or one or more third trajectories each having 3D points over time for locations and orientations of one or more points on the ripper tool attachment and/or on the hydraulic arms connecting the vehicle body and the ripper tool attachment (e.g., one or more spots at which position and/or orientation of the tool attachment or a hydraulic arm, respectively, is measured). As another example, if the vehicle is an excavator with a bucket tool attachment connected to the vehicle body by a boom hydraulic arm and a stick hydraulic arm, the one or more trajectories may include one or more first trajectories with 3D points over time each having a location and orientation of a distinct spot on the vehicle body (e.g., a spot at which vehicle position and/or orientation is measured, and with such first trajectories including rotational vehicle body movements and/or lateral vehicle movements forward and/or backward via tracks and/or wheels), and/or one or more second trajectories each having 3D points over time for locations and orientations of one or more points on the bucket tool attachment and/or on the boom and/or stick hydraulic arms.

The EMVAOC system may further use the received target trajectory information and the trained MPC predictive dynamics model (or other trained predictive dynamics model) to implement the autonomous operations of the vehicle in various manners. In particular, in at least some embodiments, the EMVAOC system generates multiple candidate action sequences to use in implementing a first portion of the target trajectories, such as for a shorter amount of time than the overall time for performing the task (seconds, such as five seconds), with each candidate action sequence including a sequence of actions that include sequential inputs to one or more of the vehicle controls. The multiple candidate action sequences may be determined in various manners, and a quantity of the candidate action sequences is selected in at least some embodiments and situations to enable the EMVAOC system to perform the generation and subsequent evaluation of the generated candidate action sequences and the further selection of one of those candidate action sequences for implementation in a real-time or near-real-time manner (e.g., in seconds; in fractions of a second, such as a tenth of a second or a one-hundredth of a second; etc.). With respect to determining the multiple candidate action sequences, one option includes considering all possible vehicle input controls and selecting each action from them, such as in a random manner or in a weighted manner (e.g., using a distribution of frequency of actions to weight the selection of each action), while other options include restricting the possible actions that are available to be selected for candidate action sequences in one or more manners, such as to eliminate action sequences that are inconsistent with the overall task (e.g., if the task includes having the vehicle move forward, to eliminate actions that include having the vehicle move backwards or stop), and/or to filter actions that would cause the vehicle to violate a specified safety constraint or other defined constraint (e.g., to move forward if doing so would move the vehicle onto a slope or other area that caused a balancing-related safety threshold to be exceeded or other safety constraint to be violated). In some embodiments and situations, a separate predictive dynamics model is generated and used to generate at least some of the candidate action sequences, such as to generate and use a trained generative machine learning model (e.g., a variational encoder model to predict likely next actions given a current state of the vehicle and its surrounding environment and given one or more target trajectories and/or tasks to be performed; a trained large language model, or LLM; etc.), such as by training the generative model over the distribution of actions in trajectories from the training data.

After the multiple candidate action sequences have been generated, the EMVAOC system performs further automated operations to evaluate the multiple candidate action sequences, and to then select one to implement, such as the candidate action sequence with the highest evaluation. In particular, in at least some embodiments and situations, the EMVAOC system uses the trained MPC predictive dynamics model (or other trained predictive dynamics model) to, for each of the candidate action sequences, predict results of performing each of the actions in the sequence for that candidate action sequence, such as to generate one or more predicted trajectories in 3D space that correspond to a portion of the target trajectories for the task to be performed (e.g., a portion of the target trajectories for a same amount of time corresponding to the time for performing the candidate action sequences). After the predicted trajectories have been generated for each candidate action sequence, the EMVAOC system may further evaluate each such candidate action sequence, such as to determine a candidate action sequence having predicted trajectories that best match the target trajectories without violating any safety constraints or other defined constraints. As part of the evaluation of a candidate action sequence, the EMVAOC system may, in at least some embodiments and situations, apply one or more defined metrics that measure differences between its predicted target trajectories and the target trajectories, and give a highest evaluation to the candidate action sequences with predicted trajectories having the smallest combined differences. As one example, if the vehicle is a bulldozer with a front blade attachment, the defined metrics may include a crosscheck error for the vehicle body that measures a distance between the locations in 2D space for the one or more points on the vehicle body between the corresponding predicted and target trajectories for the vehicle body, and/or a blade height error for the blade tool attachment that measures a distance in 3D space for the one or more points on the blade tool attachment between the corresponding predicted and target trajectories for the blade tool attachment, and/or a vehicle body orientation error that measures a distance between the orientations in 3D space for the one or more points on the vehicle body between the corresponding predicted and target trajectories for the vehicle body. It will be appreciated that other types of difference measures may be used for bulldozer vehicles and/or other vehicle types, including with respect to different types of tool attachments. As previously noted, in at least some embodiments and situations, the generation and evaluation of the multiple candidate action sequences and selection of a corresponding one of the multiple candidate action sequences to implement are performed in a real-time manner, such as to begin implementation of the first action of the selected candidate action sequence in less than one second (e.g., a tenth of a second).

After one of the multiple candidate action sequences is selected to be implemented, the EMVAOC system may begin to implement the selected candidate action sequence, including to perform at least a first action in the sequence on the vehicle, such as to use one or more hydraulic piston displacement mechanisms on the vehicle to make corresponding changes to one or more vehicle controls. In addition, the EMVAOC system may further gather additional status data about the vehicle and/or the surrounding environment as the selected candidate action sequence is implemented, such as during and/or after the implementation of the first action, or in some embodiments and situations in a substantially continuous manner. In some embodiments and situations, the EMVAOC system may continue to perform some or all of the additional actions in the selected candidate action sequence, including to continue to gather current vehicle and environment status information, such as until and unless monitored status information indicates an imminent or current violation of a safety constraint or other defined constraint—if so, the EMVAOC system may take immediate action to suspend the selected candidate action sequence and to stop the vehicle or otherwise remedy the violated constraint. In other embodiments and situations, after performing a first action in the selected candidate action sequence, the EMVAOC system may use current status information for the vehicle and surrounding environment to generate and evaluate new candidate action sequences in order to determine a next action to implement based on that current status information from one of the new candidate action sequence that is selected as best matching the next portions of the target trajectories after the first action is performed, and with such a process being repeated after each action until and unless monitored status information indicates an imminent or current violation of the safety constraint or other defined constraint—if so, the EMVAOC system may similarly take immediate action to suspend the selected candidate action sequence and stop the vehicle or otherwise remedy the violated constraint.

This process of generation and evaluation of multiple candidate action sequences and implementation of at least a first action of a selected candidate action sequence may then be performed repeatedly, such as in a continuous manner, until the defined task is completed and the vehicle's motion and/or component movements have progressed in a manner that matches or substantially matches the target trajectories for the defined task. At that time, an additional task to be performed may be determined with additional target trajectories, and the processes discussed above may be repeated for the additional task. Additional details are included below regarding performing automated operations of an EMVAOC system that include using a trained MPC predictive dynamics model or other trained predictive dynamics model to control autonomous operations of a powered earth-moving mining and/or construction vehicle.

As noted above, the autonomous control of operations of a powered earth-moving vehicle is performed in some embodiments and situations as part of fully autonomous operations of the powered earth-moving vehicle without any human input during those fully autonomous operations (e.g., to receive human input only to provide information about task goals and/or other configuration settings before the fully autonomous operations commence), including planning motion of the powered earth-moving vehicle between on-site locations and/or movement of component parts of the vehicle (e.g., hydraulic arms, tool attachments, a rotatable vehicle body, tracks and/or wheels, etc.) to accomplish one or more indicated tasks without violating any specified safety configuration data and while satisfying any other specified criteria, and implementing the planned motion/movement via automated manipulation of controls of the vehicle (e.g., based at least in part on motion/movements of the powered earth-moving vehicle and/or its component parts that are predicted by the MPC predictive dynamics model). In some embodiments and situations, the autonomous control of the operations of a powered earth-moving vehicle is performed as part of semi-autonomous operations of the powered earth-moving vehicle, including monitoring manipulation of some or all controls of the vehicle by one or more human operators (whether located in or on the vehicle, or instead remote from the vehicle) during the vehicle operations, and preventing and/or otherwise reducing effects of and/or otherwise remedying motion/movements of the powered earth-moving vehicle and/or its component parts that are predicted by the MPC predictive dynamics model to violate specified safety configuration data (e.g., to, even if not manually specified, automatically perform one or more of balancing-related operations, slippage-related operations, controlled stoppage operations, gradual turning operations, etc.) or to otherwise provide automated assistance to the actions of the human operator(s)—such preventing and/or otherwise reducing effects of and/or otherwise remedying motion/movements of the powered earth-moving vehicle and/or its component parts may, for example, include at least one of applying one or more further inputs to at least one physical control of the earth-moving vehicle (whether the same and/or different physical controls manipulated by the human operator, such as to autonomously depress the brake pedal if the human operator's activation of an accelerator pedal or other motion control would violate specified safety configuration data, to manipulate the same physical control activated by the human operator but in an opposite direction or other manner to counteract the human operator's input, etc.), or of blocking transmission of the applied inputs to the physical controls of the earth-moving vehicle, or of alerting the human operator and/or one or more other users. Furthermore, in some embodiments, such semi-autonomous operations may include monitoring a human operator's adherence to one or more target trajectories in 3D space for at least one of the vehicle body or one or more movable components of the vehicle, such as to determine predicted effects on vehicle motion and/or vehicle component movement that differ from the target trajectory(ies) by at least a defined threshold, and similarly taking automated actions for preventing and/or otherwise reducing effects of and/or otherwise remedying motion/movements of the powered earth-moving vehicle and/or its component parts away from the target trajectory(ies). Controlled operations of the powered earth-moving vehicle may in some embodiments and situations be performed while the vehicle remains at a fixed location (e.g., for a tracked excavator vehicle, to include component part movements such as vehicle body rotation and/or hydraulic arm movements and/or tool attachment movements, but not to include movement of the tracks), and may in some embodiments and situations be performed as the vehicle is in motion from an initial location to a destination location. Additional details related to implementing autonomous control of powered earth-moving vehicles in particular manners are described below.

The described techniques provide various benefits in various embodiments, including to improve efficiency and speed and accuracy and safety in operations involving controlling powered earth-moving vehicle motion and vehicle component part movements to perform tasks, including to use a trained predictive dynamics model to determine best vehicle input control actions to perform to achieve performance of a desired task with desired movement trajectories of vehicle components. In addition, in some embodiments the described techniques may be used to provide an improved GUI in which one or more users (e.g., on-site and/or remote users) may obtain and view information about operations of one or more powered earth-moving vehicles on a site, and in which an operator user may more accurately control operations of one or more such powered earth-moving vehicles. Various other benefits are also provided by described techniques, some of which are further described elsewhere herein.

As part of performing the described techniques, the EMVAOC system may in some embodiments obtain and integrate data from sensors of multiple types positioned on a powered earth-moving vehicle at a site, and use the data to determine and control motion of the powered earth-moving vehicle on the site, such as by determining current location and positioning of the powered earth-moving vehicle and its moveable component parts on the site, determining a target destination location and/or route (or ‘path’) of the powered earth-moving vehicle on the site, identifying and classifying objects and other obstacles (e.g., man-made structures, rocks and other naturally occurring impediments, other equipment, people or animals, non-level terrain, etc.) along one or more possible paths (e.g., multiple alternative paths between current and destination locations), implementing actions to address any such obstacles (e.g., move, avoid, pass over, etc.), and performing movement-related operations (e.g., balancing-related, slippage-related, steering-related, related to tool attachment placement, related to emergency stopping, related to sensor calibration, etc.) as needed during vehicle motion (e.g., on non-level surfaces). In addition, in at least some embodiments, the described systems and techniques are further used to implement coordinated actions of multiple powered earth-moving vehicles of one or more types (e.g., one or more excavator vehicles, bulldozer vehicles, front loader vehicles, grader vehicles, plowing vehicles (e.g., snow plows, dirt plows, tractors with plow attachments, etc.), loader vehicles, crane vehicles, backhoe vehicles, compactor vehicles, conveyor vehicles, dump trucks or other truck vehicles, etc.).

The described techniques may further include using the data from one or more types of sensors on a powered earth-moving vehicle to generate a site map of at least some of an environment around the vehicle (e.g., with a 3D representation of surfaces for an area of the site around the vehicle), including to determine slopes and other non-level surfaces and more generally surface heights and shapes (e.g., to create a grid of cells covering the surface(s) to be mapped, such as with each cell being sized 20 cm by 20 cm or another defined size, and to determine surface height, shape, slope, etc. for each such cell), as well as to detect other obstacles in an area around the vehicle (e.g., in at least an area reachable by a tool attachment and/or other component parts of the vehicle), and to optionally further classify the obstacles with respect to multiple defined obstacle types (e.g., having different specified safety configurations). Such data may include, for example, Light Detection and Ranging (LiDAR) data from one or more LiDAR sensors of one or more LiDAR components positioned on the vehicle, and/or image data from one or more camera devices with image sensors positioned on the vehicle, and/or infrared data from one or more infrared sensors positioned on the vehicle, and/or material type data from one or more material type sensors positioned on the vehicle, etc., and with some or all of the sensors optionally mounted on moveable portions of the vehicle (e.g., a hydraulic arm, a tool attachment, etc.) to enable movement of those sensors (e.g., separate from motion of the vehicle) to different positions to obtain additional data readings. The data related to such obstacles may be used to determine positions in 3D space around the vehicle that are prohibited in accordance with the specified safety configuration data or that otherwise trigger safety-related actions, including slopes or other non-level surfaces that exceed defined thresholds, although at least some obstacles may not be included in the prohibited 3D positions (e.g., obstacles that are to be moved as part of one or more tasks, such as rocks or other material that are within the movement capacity of the vehicle's tool attachment; non-level portions of the terrain that are not flat but do not exceed safety parameters for the vehicle to drive over; other obstacles that the vehicle or its parts may move over or through, such as sparse vegetation or water; etc.)—in at least some embodiments, each cell of a grid covering an area around some or all of a vehicle will have one or more 3D data points (e.g., of a generated 3D point cloud) that are used to determine the data for that cell.

The powered earth-moving vehicle may further use additional sensors on some or all moveable parts of the vehicle to determine positions of those parts, including relative to other parts of the vehicle. As one non-exclusive example, a first hydraulic arm attached to a vehicle body of the vehicle (e.g., a hydraulic ‘boom’ arm of an excavator vehicle) may include at least one first inclinometer sensor that measures a first angle of that first hydraulic arm relative to the vehicle body, a second hydraulic arm (if any) attached to the first hydraulic arm (e.g., a hydraulic ‘stick’ arm of an excavator vehicle attached to a hydraulic boom arm) may include at least one additional second inclinometer sensor that measures a second angle of that second hydraulic arm relative to the first hydraulic arm, a tool attachment connected to one of the hydraulic arms (e.g., a bucket tool of an excavator vehicle connected to the hydraulic stick arm) may include at least one additional third inclinometer sensor that measures a third angle of that tool attachment relative to that hydraulic arm to which it is connected, etc., with a combination of the angles from the multiple inclinometer sensors for such hydraulic arm(s) and tool attachment then used to determine positions in 3D space of those component parts relative to a connection point to the vehicle body—similar operations may be used for other types of powered earth-moving vehicles, including those having only a single set of one or more hydraulic arms connecting a vehicle body to a tool attachment, such as to not have one or more second inclinometer sensors as discussed above with respect to an example excavator vehicle). In addition, a cabin or other portion of the vehicle body may include one or more sensors to provide relative or absolute location and/or direction information (e.g., one or more GPS receivers, such as multiple GPS receivers at known locations on the vehicle body to in combination provide directional information for the vehicle body; one or more INS-DU (inertial navigation system-dual antenna) sensors that combine GPS data with compass data and other IMU data such as acceleration and angular velocity; etc.), and tracks or wheels of the vehicle may include one or more directional sensors to determine a direction of the tracks/wheels (whether an absolute direction and/or a direction relative to the vehicle body if the vehicle body and/or tracks/wheels are rotatable), with the relative directions of the tracks/wheels able to be used to determine positions in 3D space of those component parts relative to the vehicle body—if the sensors on the vehicle are able to determine an absolute position of the vehicle body, the positions of the vehicle component parts may further be determined in absolute coordinates, such as by using GPS coordinates from one or more GPS antennas mounted on the vehicle body, optionally after being corrected using real-time kinematic (RTK)-based GPS correction data transmitted via signals from a base station (e.g., at a location remote from the site at which the vehicle is located), and/or by using LiDAR and/or visual data to determine a position of the vehicle within a job site with known locations. The positions of the vehicle component parts may be represented in various manners in various embodiments (e.g., in XYZ coordinates, whether absolute or relative to a position of the vehicle body; in angle-based coordinates, such as to represent the position of an excavator vehicle's tool attachment using the first angle for the hydraulic boom arm and the second angle for the hydraulic stick arm and the third angle for the tool attachment; etc.)—the positions of the obstacles around the vehicle and/or the prohibited 3D positions may similarly be represented in the same format as used for the vehicle component parts (e.g., in angle-based coordinates relative to the same point on the vehicle's body as for moveable parts of the vehicle whose positions use such angle-based coordinates), or instead different position formats may be used for vehicle parts and prohibited 3D positions/obstacle locations, with a conversion determined between formats during use of the vehicle part position information and the information about the prohibited 3D positions/obstacle locations.

As noted above, the automated operations of the EMVAOC system may include automatically planning vehicle motion between two or more locations (e.g., between starting and ending locations on a site) and/or vehicle attachment movements while the powered earth-moving vehicle is stationary and/or in motion. In some embodiments, the EMVAOC system may include one or more planner modules, and at least one such planner module may perform such planning operations for one or more vehicle component parts, such as to determine a 3D movement/motion plan that includes a sequence of 3D positions for a vehicle's tool attachment to perform one or more tasks while avoiding prohibited 3D positions and otherwise preventing violations of safety configuration data or satisfying other specified criteria, optionally while the vehicle moves on a path between multiple locations (e.g., in accordance with other goals or planning operations being performed by the EMVAOC system, such as based on an overall analysis of a site and/or as part of accomplishing a group of multiple activities at the site). In particular, the EMVAOC system may implement autonomous control of motion of the vehicle and movements of its component parts to prevent intersection with prohibited 3D positions corresponding to the obstacles and optionally additionally corresponding to positions of component parts of the vehicle that can be reached by other moveable component parts of the vehicle (e.g., for an excavator vehicle's tracks and/or body that can be reached by the vehicle's tool attachment), whether during planning and implementing fully autonomous operations for the vehicle, and/or for motion/movements initiated in part or in whole by a human operator of the vehicle. These techniques may be further extended for motion of the vehicle between different locations on a job site, such as when moving to a destination location at which one or more tasks will be performed, while moving between locations as part of implementing one or more tasks (e.g., carrying or otherwise moving material between two locations, forming a road or lane between two locations, etc.), or otherwise performing activities involving vehicle motion—as part of doing so, the locations of obstacles along the vehicle motion path(s) may be similarly determined and used to identify prohibited 3D positions along the path(s) that are reachable by the vehicle component parts, and movement of the vehicle component parts may be similarly monitored and controlled to avoid those prohibited 3D positions not only at the initial and destination locations but also along the path(s), as well as to implement other vehicle component part positioning in accordance with specified safety configuration data (e.g., to maintain balance of the vehicle, to prevent positions of vehicle component parts that cause damage to the vehicle, etc.) or to otherwise satisfy specified criteria. Additional details are included below related to automatically controlling motion of a powered earth-moving vehicle on a job site and movement of vehicle component parts to conform with specified safety configuration data.

For illustrative purposes, some embodiments are described below in which specific types of data are acquired and used for specific types of automated operations performed for specific types of powered earth-moving vehicles, and in which specific types of autonomous operation activities are performed in particular manners. However, it will be understood that such described systems and techniques may be used with other types of data and powered earth-moving vehicles and associated autonomous operation activities in other manners in other embodiments, and that the invention is thus not limited to the exemplary details provided. In addition, the terms “acquire” or “capture” or “record” as used herein with reference to sensor data may refer to any recording, storage, or logging of media, sensor data, and/or other information related to a powered earth-moving vehicle or job site or other location or subsets thereof (unless context clearly indicates otherwise), such as by a recording device or by another device that receives information from the recording device. In addition, various details are provided in the drawings and text for exemplary purposes, but are not intended to limit the scope of the invention. For example, sizes and relative positions of elements in the drawings are not necessarily drawn to scale, with some details omitted and/or provided with greater prominence (e.g., via size and positioning) to enhance legibility and/or clarity. Furthermore, identical reference numbers may be used in the drawings to identify similar elements or acts.

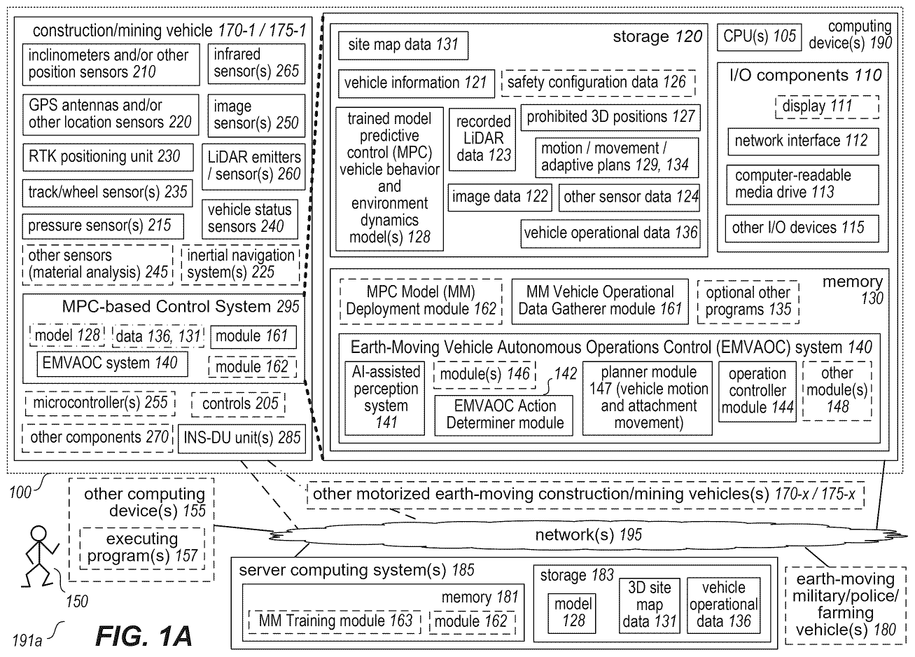

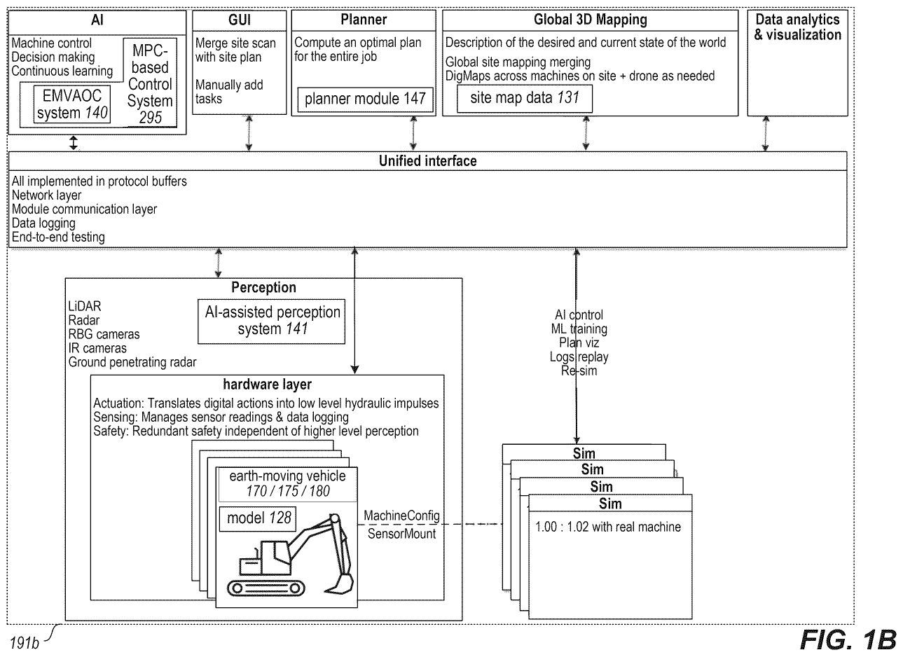

FIG. 1A is a diagram including information 191a illustrating an example embodiment of an MPC-based Control System 295 that may be used to implement at least some of the described systems and techniques to evaluate one or more candidate actions (e.g., as part of candidate action sequences) and to predict changes to the vehicle state and/or the state of a surrounding environment from performing the action(s), and of an EMVAOC (“Earth-Moving Vehicle Autonomous Operations Control”) system 140 of the MPC-based Control System 295 that may be used to implement at least some of the described systems and techniques for implementing autonomous control of powered earth-moving vehicles using one or more trained MPC predictive dynamics models or other predictive dynamics models, such as to automatically control motion of one or more powered earth-moving vehicles between locations on a job site and movement of component parts of the vehicle(s) to perform tasks while conforming with specified safety rules or other specified safety configuration data and/or to otherwise satisfy specified criteria. In some embodiments and situations, the MPC-based Control System 295 may further include one or more components used in training and deploying one or more predictive MPC dynamics models before their use, such as an MPC Model (MM) Vehicle Operational Data Gatherer module 161 that gathers actual operational data of one or more vehicles for use in training a resulting MPC dynamics model 128, and/or an MM Deployment module 162 that deploys a trained MPC dynamics model 128 to a vehicle on which that model will be used. The EMVAOC system 140 and MPC-based Control System 295 may be implemented using one or more hardware processors 105 of one or more network-accessible configured computing devices 190—such a computing device may, for example, be part of a self-contained control unit located on a powered earth-moving vehicle (e.g., without a separate cooling unit, and in some situations operable without receiving external instructions), such as when the EMVAOC system 140 is part of otherwise integrated 100 with a particular powered earth-moving construction vehicle 170-1 and/or powered earth-moving mining vehicle 175-1 (e.g., located on that powered earth-moving vehicle) or other powered earth-moving vehicle(s) 180 such as one or more military vehicles and/or police vehicles and/or farming vehicles.

Similarly, in some embodiments and situations, one or more MPC-based Control System modules (e.g., an MM Training module 163 and optionally MM Deployment module 162) may be implemented using one or more hardware processors (not shown) of one or more network-accessible configured computing systems 185, such as to receive actual vehicle operational data 136 from a particular powered earth-moving vehicle 170-1 and/or 175-1 and store in on storage 183, for module 163 executing in memory 181 to, optionally in combination with actual vehicle operational data of one or more other vehicles of a same vehicle type and optionally having the same types of tool attachments, generate a corresponding trained MPC vehicle behavior and environment dynamics model 128 specific to that vehicle type, and for module 162 optionally executing in memory 181 on the computing system(s) 185 and/or on that vehicle's computing device 190 to deploy a current copy of the trained model 128 to one or more vehicles of that type (e.g., vehicles from which the operational data used for training was gathered, other vehicles of a same vehicle type, etc.) for use in controlling automated operations of those one or more vehicles—such computing systems 185 may, for example, be separate and remote from the powered earth-moving vehicle, such as elsewhere on a job site on which the vehicle is operating, at a separate location remote from the job site (e.g., as part of a cloud execution system), etc.

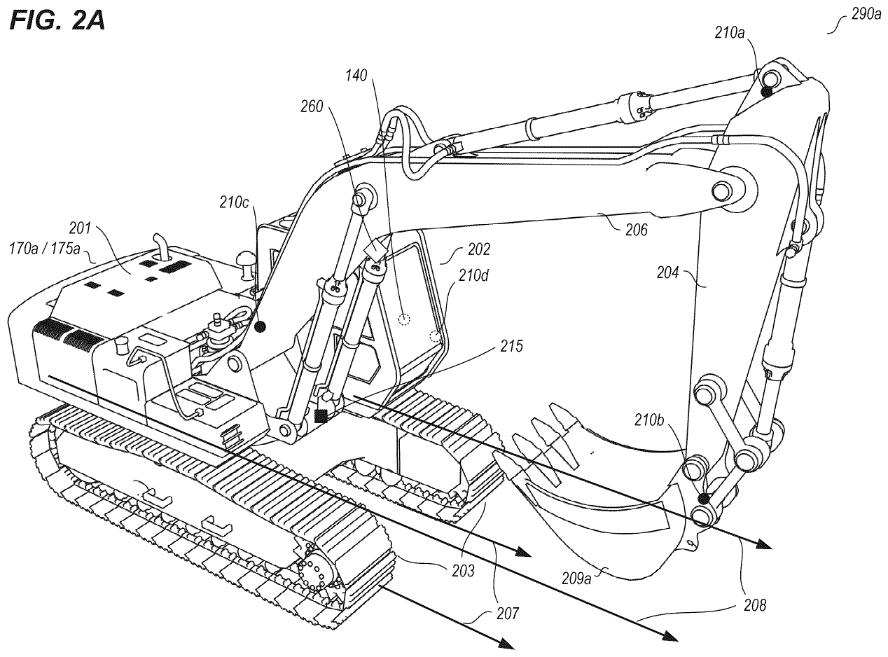

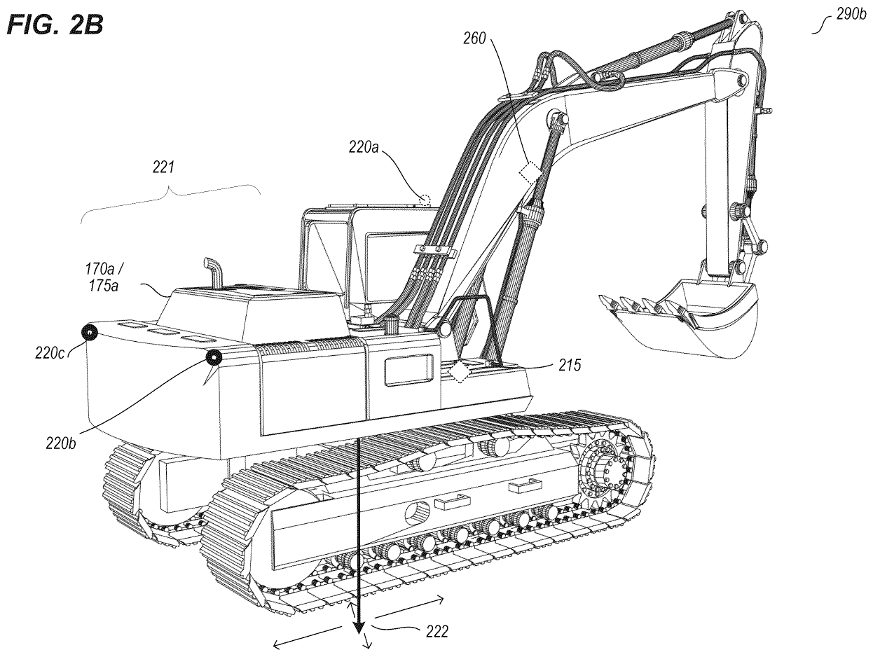

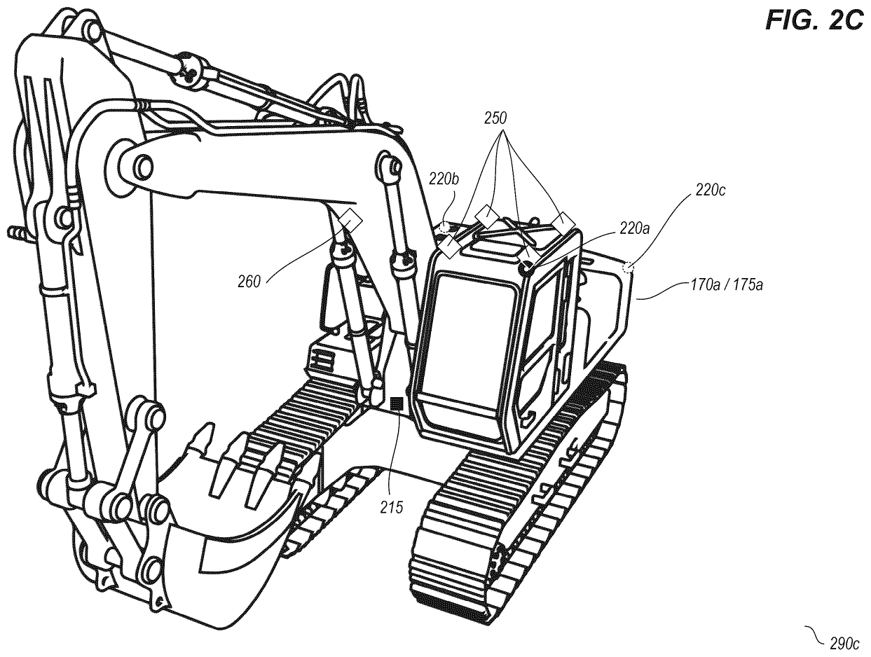

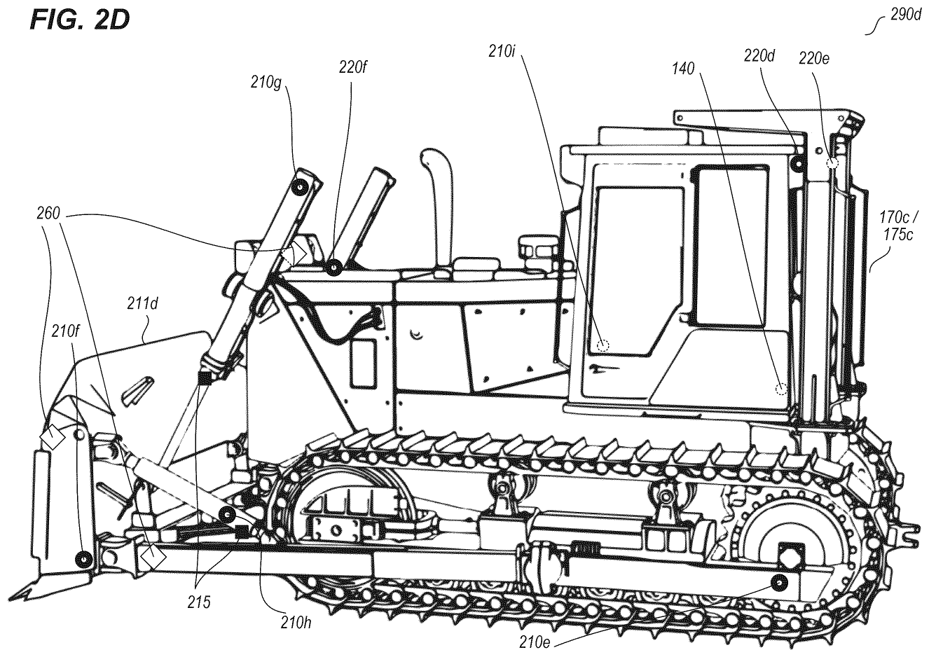

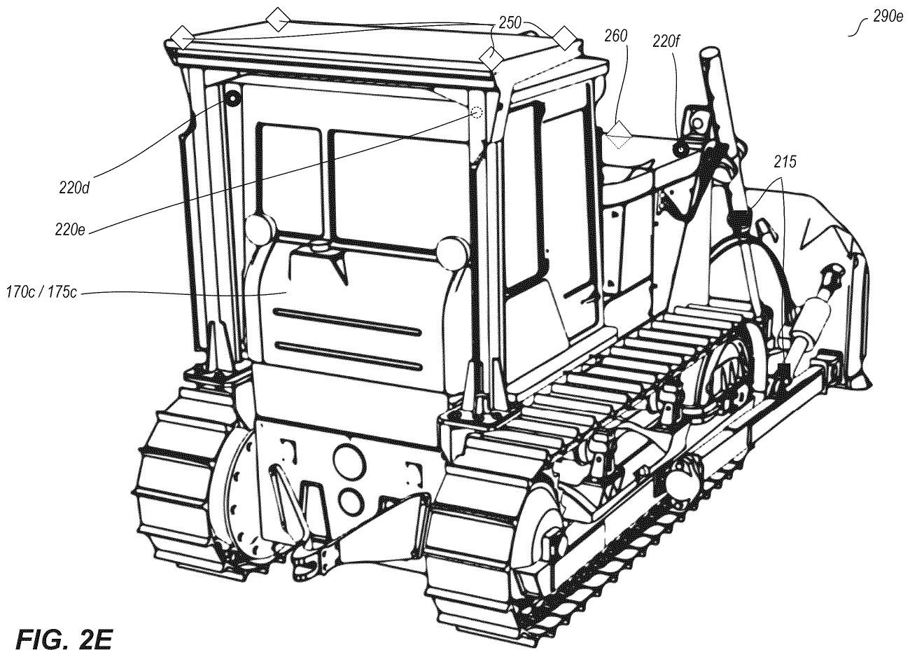

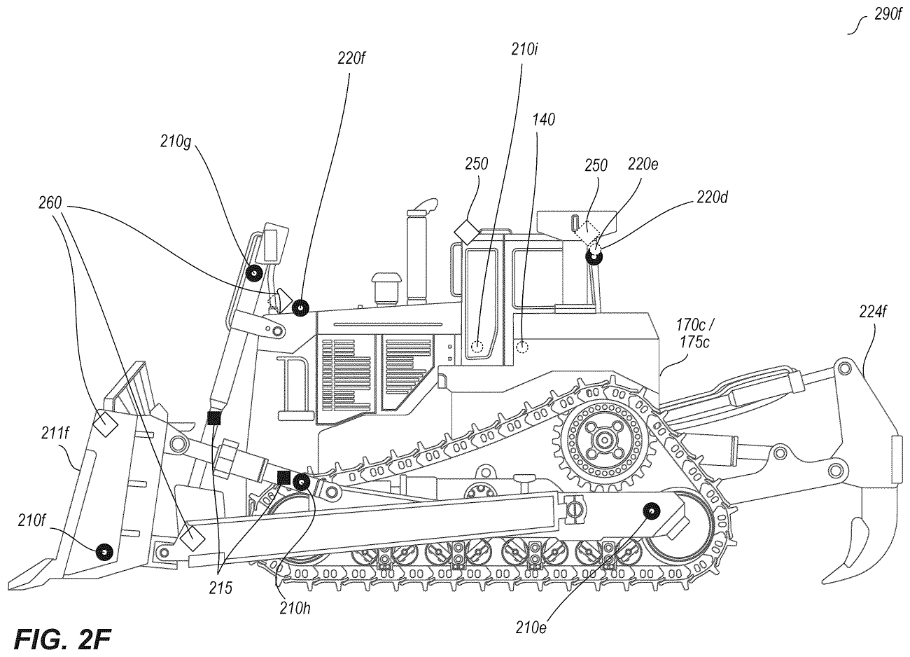

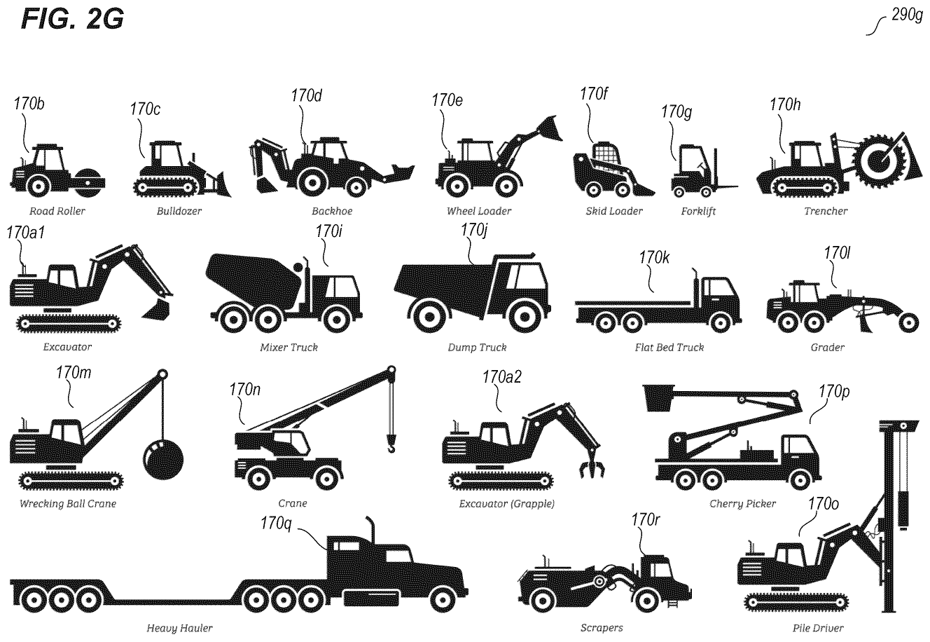

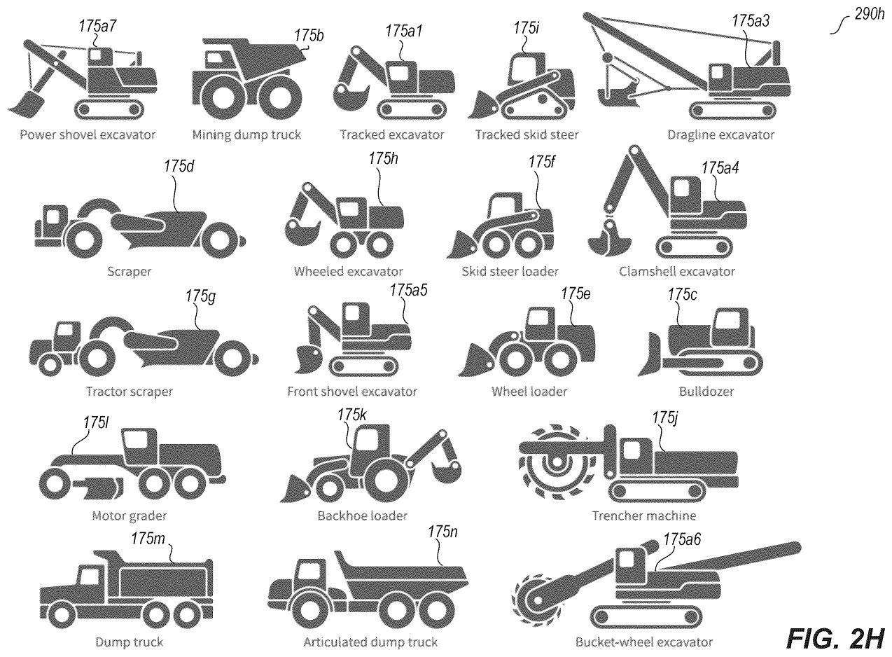

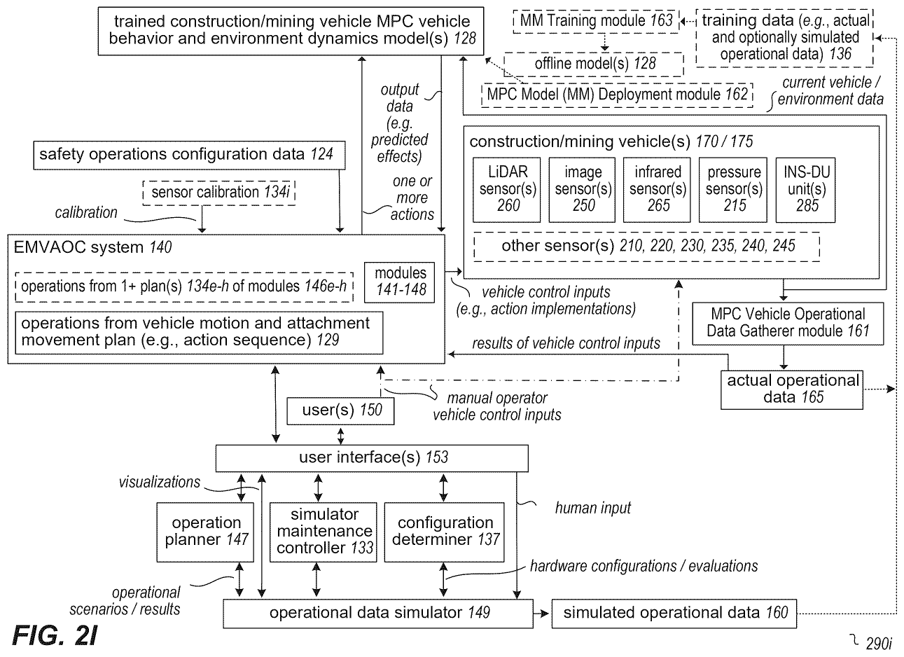

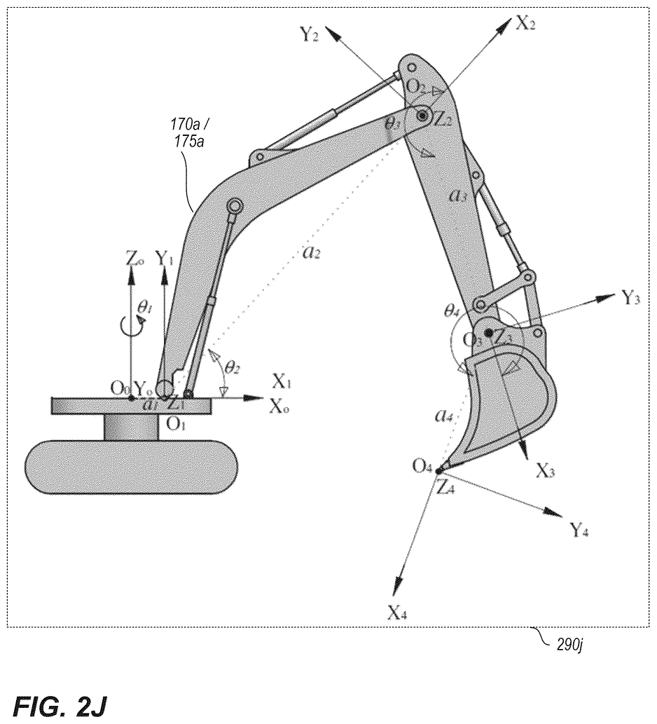

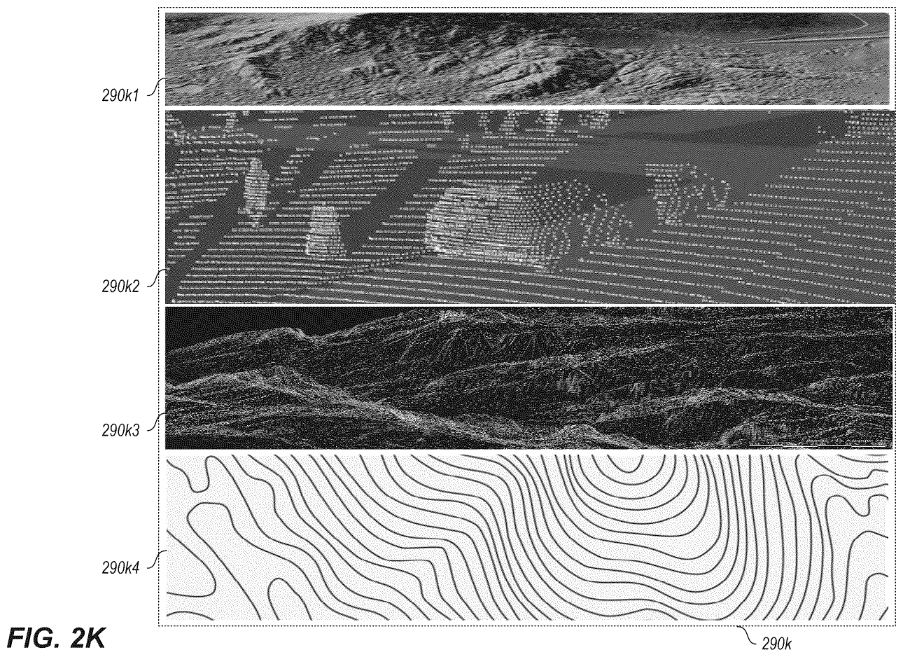

In some embodiments and situations, multiple powered earth-moving vehicles 170 and/or 175 and/or 180 may each have a separate executing copy of the EMVAOC system 140, while in other embodiments and situations, a single EMVAOC system 140 may support multiple powered earth-moving vehicles 170 and/or 175 and/or 180 (e.g., operating in a distributed manner on the multiple vehicles, such as via one or more computing devices 190 on each of the multiple vehicles that are interacting in a peer-to-peer manner), and/or may operate separately from one or more such powered earth-moving vehicles 170 and/or 175 and/or 180 (e.g., at a location on site and in communication with one or more such powered earth-moving vehicles over one or more networks 195). Similarly, in at least some embodiments and situations, the multiple powered earth-moving vehicles 170 and/or 175 and/or 180 may each have a separate copy of the MPC-based Control System 295—alternatively, in other embodiments a single MPC-based Control System 295 may support multiple powered earth-moving vehicles 170 and/or 175 and/or 180, or may operate separately from one or more such powered earth-moving vehicles 170 and/or 175 and/or 180. In some embodiments, one or more other computing devices or systems may further interact with the EMVAOC system 140 and/or MPC-based Control System 295 (e.g., to obtain and/or provide information), such as one or more other computing devices 155 each having one or more associated users and optionally executing one or more software programs 157, and/or one or more other computing systems 185 (e.g., to, in addition to executing module 163 to generate a trained MPC vehicle behavior and environment dynamics model 128 and optionally executing a module 162, optionally store and provide other data, provide supplemental computing capabilities, etc.). The one or more computing devices 190 and one or more computing systems 185 may each include any computing device or system that may receive data and/or requests and take corresponding actions as discussed herein (e.g., store the data, respond to the request, etc.). The earth-moving vehicle(s) 170 and/or 175 and/or 180 may correspond to various types of vehicles and have various forms, with non-exclusive examples illustrated in FIGS. 2A-2H.

In this example, the powered earth-moving vehicle 170-1 or 175-1 includes a variety of sensors to obtain and determine information about the powered earth-moving vehicle and its surrounding environment (e.g., a job site on which the powered earth-moving vehicle is located), including one or more GPS antennas and/or other location sensors 220, one or more inclinometers and/or other position sensors 210, one or more image sensors 250 (e.g., visible light sensors that are part of one or more cameras or other image capture devices), one or more LiDAR components 260 (e.g., with LiDAR emitters and sensors), one or more infrared sensors 265, one or more pressure sensors 215, optionally an RTK-enabled GPS positioning unit 230 that receives GPS signals from the GPS antenna(s) and RTK-based correction data from a remote base station (not shown) and optionally other data from one or more other sensors and/or devices, optionally one or more INS-DU or other IMU units 285 (e.g., each using 3-axis precision magnetometers, accelerometers and gyroscopes along with GPS data, such as RTK-corrected GPS data, for high-precision position determination) or other inertial navigation systems 225, optionally one or more track or wheel alignment sensors 235, optionally one or more other sensors 245 (e.g., material analysis sensors, sensors associated with radar and/or ground-penetrating radar and/or sonar, etc.), optionally other vehicle status sensors 240, etc. The powered earth-moving vehicle 170-1 or 175-1 may further optionally include various vehicle controls 205, one or more low-voltage microcontrollers 255 (e.g., hardware CPU(s) 105) and/or other hardware components 270 (e.g., corresponding to some or all of the components 110, 120 and 130), such as part of a self-contained control unit 190 that operates on the vehicle without a cooling unit to implement some or all of the EMVAOC system 140 (e.g., to execute some or all of the AI-assisted perception system 141, planner module 147, module(s) 146 (e.g., 146e-146i, as discussed in greater detail elsewhere herein), operation controller module 144, Action Determiner module 142, and/or optional other modules 148), MM Vehicle Operational Data Gatherer module 161 and optionally MM Deployment module 162.

During manual control of the powered earth-moving vehicle 170-1 or 175-1 to perform task(s) on a site, the MPC Vehicle Operational Data Gatherer module 161 of the MPC-based Control System 295 that is executing on the vehicle gathers actual operational data 136 of various types from the sensors on the powered earth-moving vehicle 170-1 or 175-1, such as perception data about surroundings of the vehicle (e.g., from the LiDAR sensors 260 and/or image sensors 250 and/or infrared sensors 265 and/or material analysis sensors 245), vehicle status and positioning data (e.g., from the position sensors 210 and/or location sensors 220 and/or RTK positioning unit 230 and/or track/wheel sensors 235 and/or pressure sensors 215 and/or inertial navigation system (INS) 225 and/or INS-DU unit(s) 285 and/or other vehicle status sensors 240, such as to track fuel levels, battery charge levels, etc.), and information about manual input of one or more human operators (not shown) to controls 205 of the vehicle (e.g., one or more joystick controls, pedal controls, button controls, switch controls, etc.). The module 161 then stores the operational data 136 on storage 120, and uses at least the perception data to generate a new and/or updated 3D site map 131 showing surfaces of terrain and optionally other objects (e.g., structures, vehicles, people, etc.) of at least some of an area of the site on which the vehicle is located (e.g., an area surrounding or otherwise around the vehicle), optionally in coordination with the AI-assisted perception system 141 as discussed further below. The module 161 then transmits or otherwise provides the gathered operational data 161 and the site map 131 to the separate computing system(s) 185 for use by the MM Training module 163 in training the vehicle-specific model 128, such as to provide gathered operational data 161 and/or updated site map 131 data repeatedly (e.g., periodically; in a substantially continuous manner, such as within milliseconds or centiseconds or deciseconds or seconds of gathering; etc.), and optionally in a real-time or near-real-time manner with respect to the data gathering and/or site map generation (e.g., within milliseconds or centiseconds or deciseconds or seconds of gathering), and the module 163 may similarly repeatedly use the received operational data and site map to train the model 128 (e.g., periodically; in a substantially continuous manner, such as within milliseconds or centiseconds or deciseconds or seconds of gathering; etc.), optionally after preparing the actual operational data for use in training the model 128 in a manner that is independent of an actual vehicle pose on its site.

Similarly, during autonomous operations to control the vehicle 170-1/175-1 (e.g., in a fully autonomous or semi-autonomous manner), the EMVAOC system 140 obtains some or all of the data from the sensors on the powered earth-moving vehicle 170-1 or 175-1, stores the data in corresponding databases or other data storage formats on storage 120 (e.g., vehicle information 121, image data 122, LiDAR data 123, other sensor data 124, environment object (e.g., obstacle) and other mapping (e.g., terrain) data 131, etc.), and uses the data to automatically control autonomous operations of the powered earth-moving vehicle 170-1 or 175-1 to perform specified tasks and in accordance with specified safety configuration data 126 and/or other specified criteria (not shown). In this example embodiment, the EMVAOC system 140 has modules that include an AI-assisted perception system 141 (e.g., to analyze LiDAR and/or visual data of the environment to identify objects and/or determine 3D site map data 131 for 3D surfaces of an environment around the vehicle 170-1 and/or 175-1, such as a 3D point cloud, a terrain contour map or other visual map, etc.); a vehicle motion and part movement planner module 147 (e.g., to determine how to accomplish a goal that includes movement of one or more component parts of a vehicle, optionally while avoiding prohibited 3D positions and/or performing one or more tasks having associated vehicle target trajectories, including optionally moving the powered earth-moving vehicle from its current location to a determined target destination location and determining how to handle any possible obstacles between the current and destination locations); a system operation manager module 144 (e.g., to control overall operation of the EMVAOC system and/or the vehicle 170-1 and/or 175-1); an Action Determiner module that, given one or more target trajectories for a task to be performed, determines one or more actions to implement to perform at least a next portion of the task, such as by generating and evaluating multiple candidate action sequences and selecting one of those candidate action sequences to implement; optionally one or more additional modules 146 to perform specific activities (e.g., a blade-based turn determiner module 146f to determine whether to use a blade tool attachment to participate in turning the vehicle, such as while the blade is in use in pushing/cutting/loading operations, and optionally to implement such blade-based steering; a blade load determiner module 146e to determine a degree and/or amount of loading of a blade tool attachment and any associated vehicle slippage along with corresponding activities to perform; a ripper lane coverage determiner module 146g to determine placement of ripper tool teeth for use in ripping operations and optionally to implement such ripper tool usage; a slope-based stop determiner module 146h to determine whether to implement a controlled stop based at least in part on the slope of the surface that the vehicle is approaching; a LiDAR calibration module 146i to determine calibration information for one or more on-vehicle LiDAR sensors that includes current position and orientation of the sensor relative to one or more other points on the vehicle; etc.); and optionally one or more other modules 148 (e.g., an obstacle determiner module to analyze information about potential obstacles in an environment of powered earth-moving vehicle 170-1 or 175-1 and determine corresponding information, such as a classification of the type of the obstacle, for use in generating prohibited 3D position data 127 corresponding to the obstacles and optionally parts of the vehicle; one or more modules for analyzing and describing a job site or other surrounding environment, such as quantities and/or types and/or locations and/or activities of vehicles and/or people; one or more GUI modules, including to optionally support one or more VR (virtual reality) headsets/glasses and/or one or more AR (augmented reality) headsets/glasses and/or mixed reality headsets/glasses optionally having corresponding input controllers; etc.). Such modules may generate and use additional data as part of their operations, including for the planner module to implement planned vehicle motion and vehicle component part movements and generate one or more corresponding vehicle motion plans and/or vehicle component part movement plans 129 with associated target trajectories (e.g., to perform one or more tasks, etc.), and optionally determining and implementing one or more adaptive vehicle motion/movement plans 134 (e.g., 134e-134h) from modules 146 (e.g., 146e-146h), respectively, for use in addressing changing conditions while performing other operations (e.g., to adapt an original motion/movement plan 129 in use when the changing conditions or otherwise unexpected conditions occur). In some embodiments and situations, additional data may further be used as part of training the behavioral model(s) 128 (e.g., using simulated data from one or more simulator modules, not shown). In at least some embodiments, some or all of the EMVAOC system 140 may execute on a computing device 190 of a powered earth-moving vehicle, while alternatively some or all of the EMVAOC system 140 (e.g., the planner module 147) may execute remotely from the powered earth-moving vehicle (e.g., on one or more server computing systems and/or devices 185) and exchange information with the portions of the EMVAOC system 140 executing on the powered earth-moving vehicle. Additional details related to operation of the EMVAOC system 140 are included elsewhere herein.

In this example embodiment, the one or more computing devices 190 may implement some or all of the MPC-based Control System 295 on the powered earth-moving vehicle that includes the gathered vehicle operational data 136 and trained vehicle behavior model 128 and other illustrated modules and data, including at least a copy of the module 161 (e.g., stored in memory 130 and being executed by one or more hardware CPUs 105) to gather the vehicle operational data 136 and transfer it to the separate computing system(s) 185, and a copy of the EMVAOC system 140 (e.g., stored in memory 130 and being executed by one or more hardware CPUs 105)—software instructions of the EMVAOC system 140 and/or of some or all of the MPC-based Control System 295 may further be stored on storage 120 (e.g., for loading into memory 130 at a time of execution), but are not separately illustrated in this example. The computing device(s) 190 and EMVAOC system 140 and the MPC-based Control System 295 may be implemented using a plurality of hardware components that form electronic circuits suitable for and configured to, when in combined operation, perform at least some of the techniques described herein. In the illustrated embodiment, each computing device 190 includes the one or more hardware CPUs 105 (e.g., microprocessors), storage 120, memory 130, and various input/output (“I/O”) components 110, with the illustrated I/O components including a network connection interface 112, a computer-readable media drive 113, optionally a display 111, and other I/O devices 115 (e.g., keyboards, mice or other pointing devices, microphones, speakers, one or more VR headsets and/or glasses with corresponding input controllers, one or more AR headsets and/or glasses with corresponding input controllers, one or more mixed reality headsets and/or glasses with corresponding input controllers, etc.), although in other embodiments at least some such I/O components may not be provided (e.g., if the CPU(s) include one or more microcontrollers). The memory may further include one or more optional other executing software programs 135 (e.g., an engine to provide output to one or more VR and/or AR and/or mixed reality devices and optionally receive corresponding input). The other computing devices 155 and computing systems 185 may include hardware components similar to those of a computing device 190, but with those details being omitted for the sake of brevity.

One or more other powered earth-moving construction vehicles 170-x and/or powered earth-moving mining vehicles 175-x and/or earth-moving military vehicles 180 and/or earth-moving police vehicles 180 and/or earth-moving farming vehicles 180 may similarly be present (e.g., on the same job site as powered earth-moving vehicle 170-1 or 175-1; owned by the same entity, not shown; operated by the same entity, not shown; owned and/or operated by multiple entities but all using the EMVAOC system and/or MPC-based Control System provided by a different entity; etc.) and include some or all such components 210-295 and/or 105-163 (although not illustrated here for the sake of brevity) and have corresponding trained predictive dynamics models based on gathered actual operational data, and autonomous operations controlled by the EMVAOC system (e.g., with the EMVAOC system operating on a single powered earth-moving vehicle and communicating with the other powered earth-moving vehicles via wireless communications, with the EMVAOC system executing in a distributed manner on some or all of the powered earth-moving vehicles, etc.) or by another embodiment of the EMVAOC system (e.g., with each powered earth-moving vehicle having a separate copy of the EMVAOC system executing on that powered earth-moving vehicle and optionally operating in coordination with each other, etc.). The network 195 may be of one or more types (e.g., the Internet, one or more cellular telephone networks, etc.) and in some cases may be implemented or replaced by direct wireless communications between two or more devices (e.g., via Bluetooth; LoRa, or Long Range Radio; etc.). In addition, while the example of FIG. 1A includes various types of data gathered for a powered earth-moving vehicle and its surrounding environment, other embodiments may gather and use other types of data, whether instead of or in addition to the illustrated types of data, including non-exclusive examples of image data in one or more non-visible light spectrums (e.g., infrared, ultraviolet, radiation, etc.), other energy data (e.g., sound, radiation, etc.), location data of types other than from satellite-based navigation systems, depth or distance data to an object, color data, etc. In addition, in some embodiments and situations, different devices and/or sensors may be used to acquire the same or overlapping types of data (e.g., simultaneously), and the EMVAOC system may combine or otherwise use such different types of data (e.g., via sensor fusion), including to determine differential information for a type of data.

FIG. 1B illustrates example modules and interactions used to implement autonomous operations of one or more powered earth-moving vehicles on a site, such as to provide an overview of a software and/or hardware architecture used for performing at least some of the described techniques in at least some embodiments. In particular, FIG. 1B illustrates information 191b that includes a hardware layer associated with one or more types of powered earth-moving vehicles 170 and/or powered earth-moving mining vehicles 175 and/or powered earth-moving vehicles 180 (e.g., corresponding to components 210-295 of FIG. 1A), such as to receive instructions about controlling autonomous operation of the earth-moving vehicle(s) 170/175/180, and to perform actions that include actuation (e.g., translating digital actions into low-level hydraulic impulses, including in some embodiments to use one or more piston displacement mechanisms located on a powered earth-moving vehicle 170/175/180 and positioned to manipulate one or more physical controls of the powered earth-moving vehicle when actuated, such as one or more joystick controls, pedal controls, button controls, switch controls, etc.), sensing (e.g., to manage sensor readings and data logging), safety (e.g., to perform redundant safety independent of higher-level perception operations), etc. In the illustrated example, the hardware layer interacts with or as part of a perception module (e.g., including AI-assisted perception system 141), such as to use one or more sensor types to obtain data about the earth-moving vehicle(s) and/or their environment (e.g., LIDAR data, radar data, visual data from one or more RGB camera devices, infrared data from one or more IR sensors, ground-penetrating radar data, sound data, etc.). The perception module and/or hardware layer may further interact with a unified interface that connects various modules, such as to operate a network layer and to be implemented in protocol buffers as part of providing a module communication layer, as well as to perform data logging, end-to-end testing, etc. In the illustrated example, the unified interface further interacts with an AI (artificial intelligence) module (e.g., that includes the EMVAOC system 140 and/or an MPC-based Control System 295), a GUI module, a Planner module (e.g., including planner module 147), a Global 3D Mapping module (e.g., including 3D site map 131, such as with 3D data for each of a plurality of defined cells of a grid and referred to at times herein as a ‘digmap’), one or more Sim simulation modules (e.g., operational data simulator modules that are part of the EMVAOC system 140), and one or more other modules to perform data analytics and visualization. In this example, the AI module provides functionality corresponding to machine control, decision-making, continuous learning, etc. The GUI module perform activities that include providing information of various types to users (e.g., from the EMVAOC system and/or MPC-based Control System) and manually receiving information (e.g., to be provided to the EMVAOC system and/or MPC-based Control System, such as instructions to initiate a deployment phase to provide a current copy of a vehicle-specific trained MPC dynamics model to that vehicle for use in autonomous operations to be initiated; to add tasks to be performed; to merge a site scan with a site plan; etc.). The Planner module performs operations that may include computing an optimal plan for an entire job (e.g., with various tasks to be performed in sequence and/or serially), and the Global 3D Mapping module performs activities that may include providing a description of a current state and/or desired state of an environment around the earth-moving vehicle(s), performing global site mapping merging (e.g., using DigMaps across earth-moving vehicles on the site and optionally drones, such as terrain height and shape), etc. The one or more Sim modules perform simulations to provide data from simulated operation of the one or more earth-moving vehicles, such as for use in AI control, machine learning neural network training (e.g., for one or more behavioral models), replaying logs, planning visualizations, etc. It will be appreciated that the EMVAOC system and/or MPC-based Control System may be implemented in other architectures and environments in other embodiments, and that the details of FIG. 1B are provided for illustrative purposes. In addition, while not illustrated in FIG. 1B, in some embodiments one or more specialized versions of the EMVAOC system may be used for particular types of powered earth-moving vehicles, with non-exclusive examples including the following: an Excavator Motion/Movement Control (EMC) system to control motion/movement of one or more excavator vehicles; an Excavator X Motion/Movement Control (EMC-X) system to similarly control a particular construction and/or mining excavator X vehicle; a Dump Truck Motion/Movement Control (DTMC) system to control motion/movement of one or more types of construction and/or mining dump truck vehicles; a Dump Truck X Motion/Movement Control (DTMC-X) system to similarly control a particular construction and/or mining dump truck X vehicle; a Wheel Loader Motion/Movement Control (WLMC) system to control motion/movement of one or more types of construction and/or mining wheel loader vehicles; a Wheel Loader X Motion/Movement Control (WLMC-X) system to similarly control a particular construction and/or mining wheel loader X vehicle; one or more other motion/movement control systems specific to particular types of construction and/or mining vehicles other than excavators and dump trucks and wheel loaders; a Construction Vehicle Motion/Movement Control (CVMC) system to control some or all types of powered earth-moving construction vehicles; a Mining Vehicle Motion/Movement Control (MVMC) system to control some or all types of powered earth-moving mining vehicles; etc.

It will be appreciated that computing devices, computing systems and other equipment (e.g., powered earth-moving vehicle(s) included within FIGS. 1A-1B are merely illustrative and are not intended to limit the scope of the present invention. The systems and/or devices may instead each include multiple interacting computing systems or devices, and may be connected to other devices that are not specifically illustrated, including via Bluetooth communication or other direct communication, a mesh network, through one or more networks such as the Internet, via the Web, or via one or more private networks (e.g., mobile communication networks, etc.). More generally, a device or other system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, camera devices and accessories, and various other consumer products that include appropriate communication capabilities. In addition, the functionality provided by the illustrated EMVAOC system 140 and/or the modules 161-163 may in some embodiments be distributed in various modules, some of the described functionality of the EMVAOC system 140 and/or the modules 161-163 of the MPC-based Control System may not be provided, and/or other additional functionality may be provided.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the EMVAOC system 140 and/or MPC-based Control System 295 and/or module 161 and/or module 162 executing on computing device(s) 190, by the module 163 and/or module 162 executing on computing system(s) 185, etc.) and/or data structures (e.g., in databases 121-129 and 131-136), such as by execution of software instructions of the one or more software programs and/or by storage of such software instructions and/or data structures, and such as to perform algorithms as described in the flow charts and other disclosure herein. Furthermore, in some embodiments, some or all of the systems and/or modules may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

As noted above, in at least some embodiments, data may be obtained and used by the EMVAOC system from sensors of multiple types that are positioned on or near one or more powered earth-moving vehicles, such as one or more of the following: GPS data or other location data; inclinometer data or other position data for particular movable parts of an earth-moving vehicle (e.g., a digging arm/tool attachment of an earth-moving vehicle); real-time kinematic (RTK) positioning information based on GPS data and/or other positioning data that is corrected using RTK-based GPS correction data transmitted via signals from a base station (e.g., at a location remote from the site at which the vehicle is located); track and cabin heading data; visual data of captured image(s) using visible light; depth data from depth-sensing and proximity devices such as LiDAR (e.g., depth and position data for points visible from the LiDAR sensors, such as three-dimensional, or “3D”, points corresponding to surfaces of terrain and objects) and/or other than LiDAR (e.g., ground-penetrating radar, above-ground radar, other laser rangefinding techniques, synthetic aperture radar or other types of radar, sonar, structured light, etc.); infrared data from infrared sensors; material type data for loads and/or a surrounding environment from material analysis sensors; load weight data from pressure sensors; etc. As one non-exclusive example, the described systems and techniques may in some embodiments include obtaining and integrating data from sensors of multiple types positioned on a powered earth-moving vehicle at a site, and using the data to determine and control operations of the vehicle to accomplish one or more defined tasks at the site (e.g., dig a hole of a specified size and/or shape and/or at a specified location, move one or more rocks from a specified area, extract a specified amount of one or more materials, remove hazardous or toxic material from above ground and/or underground, perform trenching, perform demining, perform breaching, etc.), including determining current location and positioning of the vehicle on the site, determining and implementing vehicle motion around the site, determining and implementing operations involving use of the vehicle's tool attachment(s) and/or arms (e.g., hydraulic arms) via their movements, etc. Such powered earth-moving construction vehicles (e.g., one or more tracked or wheeled excavators, bulldozers, tracked or wheeled skid loaders or other loaders such as front loaders and backhoe loaders, graders, cranes, compactors, conveyors, dump trucks or other trucks, deep sea construction machinery, extra-terrestrial construction machinery, etc.) and powered earth-moving mining vehicles (e.g., one or more tracked or wheeled excavators, bulldozers, tracked or wheeled skid loaders and other loaders such as front loaders and backhoe loaders, scrapers, graders, cranes, trenchers, dump trucks or other trucks, deep sea mining machinery, extra-terrestrial mining machinery, etc.) are referred to generally as ‘earth-moving vehicles’ herein, and while some illustrative examples are discussed below with respect to controlling one or more particular types of vehicles (e.g., excavator vehicles, wheel loaders or other loader vehicles, dump truck or other truck vehicles, etc.), it will be appreciated that the same or similar techniques may be used to control one or more other types of powered earth-moving vehicles (e.g., vehicles used by military and/or police for operations such as breaching, demining, etc., including demining plows, breaching vehicles, etc.). With respect to sensor types, one or more types of GPS antennas and associated components may be used to determine and provide GPS data in at least some embodiments, with one non-exclusive example being a Taoglas MagmaX2 AA. 175 GPS antenna. In addition, one or more types of LiDAR devices may be used in at least some embodiments to determine and provide depth data about an environment around an earth-moving vehicle (e.g., to determine a 3D, or three-dimensional, model of some or all of a job site on which the vehicle is situated), with non-exclusive examples including LiDAR sensors of one or more types from Livox Tech. (e.g., Mid-70, Avia, Horizon, Tele-15, Mid-40, Mid-100, HAP, etc.) and with corresponding data optionally stored using Livox's LVX point cloud file format v1.1, LIDAR sensors of one or more types from Ouster Inc. (e.g., OS0 and/or OS1 and/or OS2 sensors), etc.—in some embodiments, other types of depth-sensing and/or 3D modeling techniques may be used, whether in addition to or instead of LIDAR, such as using other laser rangefinding techniques, synthetic aperture radar or other types of radar, sonar, image-based analyses (e.g., SLAM, SfM, etc.), structured light, etc. Furthermore, one or more proximity sensor devices may be used to determine and provide short-distance proximity data in at least some embodiments, with one non-exclusive example being an LJ12A3-4-Z/BX inductive proximity sensor from ETT Co., Ltd. Moreover, real-time kinematic positioning information may be determined from a combination of GPS data and other positioning data, with one non-exclusive example including use of a u-blox ZED-F9P multi-band GNSS (global navigation satellite system) RTK positioning component that receives and uses GPS, GLONASS, Galileo and BeiDou data, such as in combination with an inertial navigation system (with one non-exclusive example including use of MINS300 by BW Sensing) and/or a radio that receives RTK correction data (e.g., a Digi XBee SX 868 RF module, Digi XBee SX 900 RF module, etc.). Other hardware components that may be positioned on or near an earth-moving vehicle and used to provide data and/or functionality used by the EMVAOC system include the following: one or more inclinometers (e.g., single axis and/or double axis) or other accelerometers (with one non-exclusive example including use of an inclination sensor by DIS sensors, such as the QG76 series); a CAN bus message transceiver (e.g., a TCAN 334 transceiver with CAN flexible data rate); one or more low-power microcontrollers (e.g., an i.MX RT1060 Arm-based Crossover MCU microprocessor from NXP Semiconductors; an ARM Cortex-M7 at 600 MHz, whether operating on its own or present on a PJRC Teensy 4.1 Development Board; a Grove 12-bit Magnetic Rotary Position Sensor AS5600, etc.) or other hardware processors, such as to execute and use executable software instructions and associated data of the EMVAOC system; one or more voltage converters and/or regulators (e.g., an ST LT1576 or LD1117 or LM217 or LM317 adjustable voltage regulator, etc.); a voltage level shifter (e.g., using a field effect transistor, such as a Fairchild Semiconductor BSS138 N-Channel Logic Level Enhancement Mode Field Effect Transistor); etc. In addition, in at least some embodiments and situations, one or more types of data from one or more sensors positioned on an earth-moving vehicle may be combined with one or more types of data (whether the same types of data and/or other types of data) acquired from one or more positions remote from the earth-moving vehicle (e.g., from an overhead location, such as from a drone aircraft, an airplane, a satellite, etc.; elsewhere on a site on which the earth-moving vehicle is located, such as at a fixed location and/or on another earth-moving vehicle of the same or different type; etc.), with the combination of data used in one or more types of autonomous operations as discussed herein. Additional details are included below regarding positioning of data sensors and use of corresponding data, including with respect to the examples of FIGS. 2A-2H.

As is also noted above, automated operations of an EMVAOC system may include determining current location and other positioning of a powered earth-moving vehicle on a site in at least some embodiments. As one non-exclusive example, such position determination may include using one or more track sensors to monitor whether or not a vehicle's tracks are aligned in the same direction as the vehicle's cabin and/or body, and using GPS data (e.g., from 3 GPS antennas located on the vehicle's cabin and/or body, such as in a manner similar to that described with respect to FIGS. 2A-2H) optionally in conjunction with an inertial navigation system to determine the rotation of the cabin and/or vehicle body (e.g., relative to true north). When using data from multiple GPS antennas, the data may be integrated in various manners, such as by using a microcontroller located on the powered earth-moving vehicle, and with additional RTK (real-time kinetic) positioning data optionally used to reinforce and provide further precision with respect to the GPS-based location (e.g., to achieve 1-inch precision or better). In addition, in some embodiments and situations, LiDAR data is used to assist in position determination operations, such as by surveying the surrounding environment around the powered earth-moving vehicle (e.g., some or all of a job site on which the powered earth-moving vehicle is located, such as terrain of the job site and objects on the job site) and confirming a current location of the powered earth-moving vehicle in two-dimensional (“2D”) and/or three-dimensional (“3D”) space, whether an absolute location (e.g., using GPS locations) and/or a relative location (e.g., using one or more points on the vehicle or other defined point(s) as a center point relative to which other points are mapped), and in some cases relative to a 2D and/or 3D site map of the job site generated from the LiDAR data and/or from analysis of visual data of images (e.g., a 3D point cloud having a plurality of data points each with an associated position in 3D space and representing a point on a surface, such as the ground or other terrain, an obstacle or other object above the ground, etc.; other types of 3D representations, such as meshes, planar surfaces or other types of surfaces, parametric models, depth-maps, RGB-D, voxels, etc.; 2D point clouds and/or other 2D representations; etc.). Additional details are included below regarding automated operations to determine current location and other positioning of a powered earth-moving vehicle on a site.

In addition, automated operations of an EMVAOC system may further include determining a target destination location and/or path of a powered earth-moving vehicle on a job site or other geographical area. For example, one or more planner modules of the EMVAOC system determine a current target destination location and/or path of a powered earth-moving vehicle (e.g., in accordance with other goals or planning operations being performed by the EMVAOC system, such as based on an overall analysis of a site and/or as part of accomplishing a group of multiple activities at the site), such as to include one or more target trajectories for one or more points on the vehicle body and/or component parts. In addition, the motion of the powered earth-moving vehicle from a current location to a target destination location or otherwise along a determined path may be initiated in various manners, such as by an operator module of the EMVAOC system that acts in coordination with the one or more planner modules (e.g., based on a planner module providing instructions to the operator module about current work to be performed, such as work for a current day that involves the powered earth-moving vehicle leaving a current work area and moving to a new area to work), or directly by a planner module (e.g., to move to a new location along a path to perform terrain leveling and/or to prepare for digging). In other embodiments, determination of a target destination location and/or path and initiation of powered earth-moving vehicle motion may be performed in other manners, such as in part or in whole based on input received from one or more human users or other sources. Additional details are included below regarding such automated operations to determine a target destination location and/or path of a powered earth-moving vehicle on a site.

Automated operations of an EMVAOC system may further in at least some embodiments include identifying and classifying obstacles (if any) along one or more paths between current and destination locations, and implementing actions to address any such obstacles. For example, LiDAR data (or other depth-sensing data) and/or visual data may be analyzed to identify objects that are possible obstacles and as part of classifying a type of each obstacle, and other types of data (e.g., infrared, material type, sound, etc.) may be further used as part of classifying an obstacle type (e.g., to determine whether an obstacle is a human or animal, such as based at least in part by having a temperature above at least one first temperature threshold, whether an absolute temperature threshold or a temperature threshold relative to a temperature of a surrounding environment; whether an obstacle is a running vehicle, such as based at least in part by having a temperature above at least one second temperature threshold, whether an absolute temperature threshold or a temperature threshold relative to a temperature of a surrounding environment, and/or based on sounds being emitted; to estimate weight and/or other properties based at least in part on one or more types of material of the obstacle; etc.), and in some embodiments and situations by using one or more trained machine learning models (e.g., using a point cloud analysis routine for object classification) or via other types of analysis (e.g., image analysis techniques). As one non-exclusive example, each obstacle may be classified on a scale from 1 (easy to remove) to 10 (not passable), including to consider factors such as whether an obstacle is a human or other animal, is another vehicle that can be moved (e.g., using coordinated autonomous operation of the other vehicle), is infrastructure (e.g., cables, plumbing, etc.), based on obstacle size (e.g., using one or more size thresholds) and/or obstacle material (e.g., is water, oil, soil, rock, etc.) and/or other obstacle attribute, etc., as discussed further below. In particular, one non-exclusive example of classifying objects includes an example classification system as follows: class 1, a small object that a powered earth-moving vehicle can move over without taking any avoidance action; class 2, a small object that is removeable (e.g., within the moving capabilities of a particular type of powered earth-moving vehicle and/or of any of the possible powered earth-moving vehicles, optionally within a defined amount of time and/or other defined limits such as weight and/or size and/or material type, such as to have a size that fits within a bucket attachment of the vehicle or is graspable by a grappling attachment of the vehicle, and/or to be of a weight and/or material type and/or density and/or moisture content within the operational limits of the vehicle) moving a large pile of dirt (requiring numerous scoops/pushes) and/or creating a path (e.g., digging a path through a hill, filling a ravine, etc.) and/or for which the vehicle can move over without taking any avoidance action; class 3, a small object that is removeable but for which the vehicle cannot safely move over within defined limits without taking any avoidance action; class 4, a small-to-medium object that is removeable but may not be possible to do so within defined time limits and/or other limits and for which avoidance actions are available; class 5, a medium object that is not removeable within defined time limits and/or other limits and for which avoidance actions are available; class 6, a large object that is not removeable within defined time limits and/or other limits and for which avoidance actions are available; class 7, an object that is sufficiently large and/or structurally in place to not be removeable within defined time limits and/or other limits and for which avoidance actions are not available within defined time limits and/or other limits; classes 8-10 being small animals, humans, and large animals, respectively, which cause movement of the vehicle to be inhibited (e.g., to shut the vehicle down) to prevent damage (e.g., even if within the capabilities of the vehicles to remove and/or avoid the obstacle); etc. A similar system of classifying non-object obstacles (e.g., non-level terrain surfaces) may be used, such as to correspond to possible activities of a powered earth-moving vehicle in moving and/or avoiding the obstacle (e.g., leveling a pile or other projection of material, filling a cavity, reducing the slope e.g., incline or decline, etc.) including in some embodiments and situations to consider factors such as steepness of non-level surfaces, traction, types of surfaces to avoid (e.g., any water, any ice, water and/or ice for a cavity having a depth above a defined depth threshold, empty ditches or ravines or other cavities above a defined cavity size threshold; etc.).

Such classifying of obstacles may further be used as part of determining a path between a current location and a target destination location, such as to select or otherwise determine one or more of multiple alternative paths to use if one or more obstacles are of a sufficiently high classified type (e.g., not capable of being moved by the earth-moving vehicle, such as at all or within a defined amount of time and/or other defined limits, and/or being of class 7 of 10 or higher) are present along what would otherwise be at least one possible path (e.g., a direct path between the current location and the target destination location). For example, depending on information about an obstacle (e.g., a type, distance, shape, depth, material type, etc.), the automated operations of the EMVAOC system may determine to, as part of the autonomous operations of the powered earth-moving vehicle, perform at least one of (1) removing the obstacle from a path and moving along that path to the target destination location, or (2) moving in an optimized path around the obstacle to the target destination location, or (3) inhibiting motion of the powered earth-moving vehicle, and in some cases, to instead initiate autonomous operations of a separate second powered earth-moving vehicle to move to the target destination location as a replacement vehicle and/or to initiate a request for human intervention. Additional details are included below regarding such automated operations to classify obstacles and to use such information as part of path determination and corresponding powered earth-moving vehicle actions.

In addition, while the autonomous operations of a powered earth-moving vehicle controlled by the EMVAOC system may in some embodiments be fully autonomous and performed without any input or intervention of any human users (e.g., fully implemented by an embodiment of the EMVAOC system executing on that powered earth-moving vehicle without receiving human input and without receiving external signals other than possibly one or more of GPS signals and RTK correction signals), in other embodiments the autonomous operations of a powered earth-moving vehicle controlled by the EMVAOC system may include providing information to one or more human users about the operations of the EMVAOC system and optionally receiving information from one or more such human users (whether on-site or remote from the site) that are used as part of the automated operations of the EMVAOC system (e.g., a target destination location, a high-level work plan, etc.), such as via one or more GUIs (“graphical user interfaces”) displayed on one or more computing device that provide user-selectable controls and other options to allow a user to interactively request or specify types of information to display and/or to interactively provide information for use by the EMVAOC system.

FIGS. 2A-2H illustrate examples of earth-moving vehicles and types of on-vehicle data sensors positioned to support autonomous operations on a site.

In particular, with respect to FIG. 2A, information 290a about an example powered earth-moving construction vehicle 170a and/or mining vehicle 175a is illustrated, which in this example is a tracked excavator vehicle, using an upper-side-frontal view from the side of the digging boom arm (or ‘boom’) 206 and stick arm (or ‘stick’) 204 and opposite the side of the cabin 202, with the earth-moving vehicle 170a/175a further having a main vehicle body 201 (e.g., enclosing an counterweight 221 and engine, and including the cabin 202, also referred to at times herein as an upper chassis) with an underlying lower chassis, tracks 203 and bucket (or ‘scoop’ or ‘claw’) tool attachment 209a—in other embodiments, other types of digging arm tool attachments may be used such as, for example, a hydraulic thumb, coupler, breaker, compactor, digging bucket, grading bucket, hammer, demolition grapple, tiltrotator, etc. Four example inclinometers 210 are further illustrated at positions that beneficially provide inclinometer data to compute the position of the bucket and other parts of the digging arms relative to the position of the cabin of the earth-moving vehicle. In this example, three inclinometers 210a-210c are mounted at respective positions on the digging arms of the earth-moving vehicle (position 210c near the intersection of the digging boom arm and the body of the earth-moving vehicle, position 210b near the intersection of the digging stick arm and the bucket attachment, and position 210a near the intersection of the digging boom and stick arms), such as to use single-axis inclinometers in this example, and with a fourth inclinometer 210d mounted within the cabin of the earth-moving vehicle and illustrated at an approximate position using a dashed line, such as to use a dual-axis inclinometer that measures pitch and roll angles—data from the inclinometers may be used, for example, to track the position of the earth-moving vehicle arms/attachment, including when a track heading direction 207 is determined to be different (not shown in this example) from a cabin/body heading direction 208. This example illustrates a position of one or more pressure sensors 215, which in this example are positioned along one or more pressure pipes (not shown) connected to the bottom of one or more pistons (or ‘cylinders’) configured to raise and lower the digging boom arm 206. This example further illustrates a position of a LiDAR component 260, which in this example is positioned on the underside of the digging boom arm 206 near its bend in the middle, and as such is movable along with the movements of the digging boon arm 206, as well as in some embodiments being independently movable (e.g., to rotate, tilt, swivel, etc.)—in other embodiments, the LiDAR component 260 may be located in other positions on the vehicle 170a/175a and/or may be one of multiple LiDAR components positioned at different locations on the vehicle. The vehicle may further have INS-DU or other IMU unit(s), not shown in this example. It will be appreciated that other quantities, positionings and types of illustrated sensors/components may be used in other embodiments.

FIGS. 2B and 2C continue the example of FIG. 2A, and illustrate information 290b and 290c, respectively, about three example GPS antennas 220 at positions that beneficially provide GPS data to assist in determining the positioning and direction of the cabin/body of the earth-moving vehicle 170a/175a, including to use data from the three GPS antennas to provide greater precision than is available from a single GPS antenna. In this example, the three GPS antennas 220a-220c are positioned on the earth-moving vehicle body and proximate to three corners of the vehicle body (e.g., as far apart from each other as possible), such that differential information between GPS antennas 220a and 220c may provide cabin heading direction information, and differential information between GPS antennas 220b and 220c may provide lateral direction information at approximately 90° from that cabin heading direction information. In particular, in FIG. 2B, the example earth-moving vehicle is shown using a side-rear view from the side of the arms, with GPS antennas 220b and 220c illustrated on the back of the body at or below the top of that portion of the body, and with an approximate position of GPS antenna 220a on the cabin top near the front illustrated with dashed lines (e.g., as illustrated further in FIG. 2C). FIG. 2B further illustrates the counterweight 221 at the back of the vehicle body, and illustrates a center of gravity 222 of the vehicle that moves forward and backward as the arms and attachment are moved while the cabin/upper chassis is aligned with the tracks, and may move in other directions as the cabin/upper chassis rotates and/or as the arms and attachment are moved while the cabin/upper chassis is not aligned with the tracks (not shown). In FIG. 2C, the example earth-moving vehicle is shown using an upper-side-frontal view from the side of the cabin, with GPS antenna 220a shown on the cabin top near the front on the same side as GPS antenna 220c, and with the positions of GPS antennas 220b and 220c illustrated through the body with dashed lines (e.g., just below the top of the back of the body, as illustrated in FIG. 2B). While not illustrated in FIGS. 2B-2C, some or all of the GPS antennas may be enabled to receive and use RTK data to further improve the accuracy of the GPS signals that are produced, such as by each being part of or otherwise associated with a GPS receiver including an RTK radio that receives and uses RTK-based GPS correction data transmitted from a base station (e.g., at a location remote from the site at which the earth-moving vehicle is located) to improve accuracy of the GPS signals from the GPS antennas, so as to be part of one or more RTK-enabled GPS positioning units. The LiDAR component 260 and pressure sensor 215 are also illustrated, using dashed lines in FIG. 2B to indicate the location on the underside of the digging boom arm (for the LiDAR component) and bottom of the piston(s) (for the one or more pressure sensors) due to the boom arm blocking a direct view of the component 260, and being directly visible in FIG. 2C. FIG. 2C also illustrates possible locations of one or more RGB cameras 250 with image sensors (not shown separately) that gather additional visual data about an environment of the vehicle 170a/175a from visible light—in this example, four cameras are used on top of the cabin (e.g., to in the aggregate provide visual coverage of some or all of 360° horizontally), with two on each side, and optionally with the two front camera facing partially or fully forwards and the two back cameras facing partially or fully backwards, although in other embodiments other camera configurations and/or types may be used (e.g., one or more cameras with panoramic view angles, such as to each cover some or all of 360° horizontally). In at least some embodiments and situations, some or all such cameras may be independently movable (e.g., to rotate, tilt, swivel, etc.) at their positions, and may further in at least some such embodiments be positioned on one or more moveable component parts of the vehicle (e.g., a hydraulic arm, attachment, etc.). In addition, in some embodiments and situations, the camera positioning may include having one or two forward-facing cameras (e.g., cameras that each produces perspective rectilinear images and/or video with a standard field of view and that in aggregate cover all or substantially all of the front area around the vehicle, such as all but a small area blocked by a front attachment of the vehicle), and one or two backward-facing camera (e.g., cameras that each produces panoramic images and/or video with a wide-angle field of view of 120° or 150° or 180° or more that covers the back and optionally some or all of the sides of vehicle). It will be appreciated that other quantities, positionings and types of GPS antennas (and/or antennas for other types of satellite-based navigation systems) and/or other sensors/components may be used in other embodiments.

FIGS. 2D-2H continue the examples of FIGS. 2A-2C, with FIGS. 2D and 2E illustrating further example details 290d and 290e respectively about another earth-moving construction vehicle 170c and/or mining vehicle 175c, which in this example is a bulldozer vehicle having a blade attachment 211d (although other tool attachments may be used in other embodiments), such as to illustrate example positions for GPS receivers 220 and/or inclinometers 210 and/or one or more LiDAR components 260 and/or one or more cameras 250 and/or one or more pressure sensors 215. In particular, FIG. 2D illustrates example information 290d that includes various example inclinometers 210e-210i, example GPS antennas/receivers 220d-220f, and possible locations for one or more LiDAR components 260 and one or more pressure sensors 215. The example inclinometers 210e-210i are illustrated at positions that beneficially provide inclinometer data to compute the location of the blade or other front attachment (and optionally other parts of the bulldozer, such as the hydraulic arms) relative to the cabin of the bulldozer vehicle (e.g., at position 210e near the intersection of the track spring lifting arm and the body of the vehicle, position 210f near the intersection of the track spring lifting arm and the blade or other attachment, position 210g at one end of a hydraulic arm, position 210h at one end of the tilt cylinder, etc.), such as to use single-axis inclinometers in this example, and with another inclinometer 210i mounted within the cabin of the vehicle and illustrated at an approximate position using a dashed line, such as to use a dual-axis inclinometer that measures pitch and roll-data from the inclinometers may be used, for example, to track the position of the track spring lifting arm and attachment relative to the cabin/body of the vehicle. The example GPS antennas/receivers 220 are illustrated at positions that beneficially provide GPS data to assist in determining the positioning and direction of the cabin/body, including to use data from the three GPS antennas to provide greater precision than is available from a single GPS antenna. In this example, the three GPS antennas 220d-220f are positioned on the vehicle body and proximate to three corners of the vehicle body (e.g., as far apart from each other as possible), such that differential information between GPS antennas 220f and 220e may provide cabin heading direction information, and differential information between GPS antennas 220d and 220e may provide lateral direction information at approximately 90° from that cabin heading direction information. The example one or more LiDAR components 260 are illustrated at one or more possible positions that beneficially provide LiDAR data about some or all of an environment around the vehicle 170c/175c, such as to be positioned on one or more sides of the blade/scoop attachment (e.g., to have a view to the side(s) of the vehicle) and/or a top or bottom (not shown) of the blade/scoop attachment (e.g., to have a view forwards), and/or on sides of one or more of the hydraulic arms (e.g., to have a view to the side(s) of the vehicle), and/or on a front of the vehicle body (e.g., near the top to have a view forwards over the blade/scoop attachment), etc. The example one or more pressure sensors 215 are illustrated at one or more possible positions to connect to pressure pipes (not shown) at the bottom of one or more pistons controlling movement of the attachment—in some embodiments, at least one pressure sensor directly measures pressure on a tool attachment (e.g., blade 211, such as 211d and/or 211f) from its interactions with surrounding terrain (e.g., pushing a portion of the terrain), and in some embodiments such pressure measurements are inferred and/or predicted or otherwise assessed from readings of one or more other sensors (e.g., vehicle speed; engine RPMs, or revolutions per minute; etc.). FIG. 2E also illustrates possible locations of one or more RGB cameras 250 that gather additional visual data about an environment of the vehicle 170c/175c—in this example, four cameras are used on top of the cabin (e.g., to in the aggregate provide visual coverage of some or all of 360° horizontally), with two on each side, and optionally with the two front camera facing partially or fully forwards and the two back cameras facing partially or fully backwards, although in other embodiments other camera configurations and/or types may be used (e.g., one or more cameras with panoramic view angles, such as to each cover some or all of 360° horizontally). In particular, in FIG. 2D, the example earth-moving vehicle is shown using a side view, with GPS antennas 220d and 220e illustrated on the back of the vehicle body at or below the top of that portion of the vehicle body (using dashed lines to illustrate position 220e), and with an approximate position of GPS antenna 220f on the vehicle body top near the front—the positions 220d-220f are further illustrated in information 290e of FIG. 2E, in which the example earth-moving vehicle is shown using an upper-side-back view, with GPS antenna 220f shown on the body top near the front on the same side as GPS antenna 220e. While not illustrated in FIGS. 2D-2E, some or all of the GPS antennas may be enabled to receive and use RTK data to further improve the accuracy of the GPS signals that are produced, such as by each being part of or otherwise associated with a GPS receiver including an RTK radio that receives and uses RTK-based GPS correction data transmitted from a base station (e.g., at a location remote from the site at which the vehicle is located) to improve accuracy of the GPS signals from the GPS antennas, so as to be part of one or more RTK-enabled GPS positioning units. The vehicle may further have one or more INS-DU or other IMU units, which are not shown in this example. It will be appreciated that other quantities, positionings and types of GPS antennas (and/or antennas for other types of satellite-based navigation systems) and/or inclinometers and/or other sensors/components may be used in other embodiments.

FIG. 2F continues the examples of FIGS. 2D-2E, and illustrates information 290f to show an example of an alternative configuration of a bulldozer vehicle 170c/175c in which the vehicle is equipped with both a front tool attachment and a rear tool attachment. In the example of FIG. 2F, the front tool attachment is a blade 211f, and the rear tool attachment is a ripper 224f with one or more teeth. Various sensors and components may be positioned on the vehicle in a manner similar to that of FIGS. 2D-2E, including illustrated elements 140, 210e-210i, 215, 220d-220f, 250 and 260.

FIGS. 2G and 2H illustrate respective information 290g and 290h about a variety of non-exclusive example types of powered earth-moving construction vehicles 170 and powered earth-moving construction vehicles 175 that may be controlled by embodiments of the EMVAOC system. FIG. 2G includes two example earth-moving tracked construction excavator vehicles 170a shown with different attachments (excavator vehicle 170a1 with a bucket attachment, and excavator vehicle 170a2 with a grapple attachment) that may be controlled by the EMVAOC system. Other example types of earth-moving construction vehicles 170 that are illustrated in FIG. 2G include a bulldozer 170c; a backhoe loader 170d; a wheel loader 170e; a skid steer loader 170f; a dump truck 170j; a forklift 170g; a trencher 170h; a mixer truck 170i; a flatbed truck 170k; a motorized grader 170l; a wrecking ball crane 170m; a truck crane 170n; a cherry picker 170p; a heavy hauler 170q; a scraper 170r; a pile driver 1700; a road roller 170b; etc. It will be appreciated that other types of earth-moving construction vehicles may similarly be controlled by the EMVAOC system in other embodiments. In a similar manner, FIG. 2H illustrates several example earth-moving tracked mining excavator vehicles 175a shown with different attachments (excavator vehicle 175a1 with a bucket attachment, excavator vehicle 175a3 with a dragline attachment, excavator vehicle 175a4 with a clamshell extractor attachment, excavator vehicle 175a5 with a front shovel attachment, excavator vehicle 175a6 with a bucket wheel extractor attachment, excavator vehicle 175a7 with a power shovel attachment, etc.) that may be controlled by the EMVAOC system. Other example types of earth-moving mining vehicles 175 that are illustrated in FIG. 2H include a dump truck 175m; an articulated dump truck 175n; a mining dump truck 175b; a bulldozer 175c; a scraper 175d; a tractor scraper 175g; a wheel loader 175e; a wheeled skid steer loader 175f; a tracked skid steer loader 175i; a wheeled excavator 175h; a backhoe loader 175k; a motor grader 175j; a trencher 175l; etc. It will be appreciated that other types of earth-moving mining vehicles may similarly be controlled by the EMVAOC system in other embodiments. In addition, while various types of sensors are not illustrated in FIGS. 2G-2H, it will be appreciated that such sensors (e.g., LiDAR sensors, image sensors of cameras, infrared sensors, material type sensors, etc.) may be mounted on the respective powered earth moving vehicles 170 and/or 175 at various positions, such as at the same or analogous positions as the sensors discussed with respect to FIGS. 2A-2H, or instead in other positions.

FIGS. 2I-2J illustrate examples of modules and interactions and information used to implement autonomous operations of one or more powered earth-moving vehicles based at least in part on gathered environment data. In particular, FIG. 2I illustrates information 290i about a powered earth-moving vehicle behavior and environment dynamics model 128 that is used by the EMVAOC system 140 to implement determined autonomous operations of one or more earth-moving vehicles 170/175/180, such as to supply input data to the model 128 corresponding to a current state and environment of the earth-moving vehicle(s) and about candidate actions sequences for vehicle motion and/or attachment movement operations to be performed for one or more tasks (e.g., from an Action Determiner module 142 of the EMVAOC system 140 based on task information from a planner module or other source) and safety operations configuration data 124 to use (e.g., related to operations involving balancing, slippage, prohibited 3D positions, etc.), and to receive corresponding output data from the model 128 that predicts effects of those candidate action sequences over time and is used by the EVMAOC system 140 to select one of the candidate action sequences and to provide resulting operation control instructions to the earth-moving vehicle(s) for at least a first action of the selected candidate action sequence—in this example, input data to the EMVAOC system 140 further includes one or more of information 134e about a plan to implement automated operations for controlling loading of a blade tool attachment (such as from module 146e using one or more blade load prediction models and predicted estimated blade load data, not shown), information 134f about a plan to implement automated operations for controlling vehicle steering using a blade tool attachment (such as from module 146f), information 134g about a plan to implement automated operations for controlling use of a ripper tool attachment to loosen ground materials for subsequent blade tool operations (such as from module 146g), information 134h about a plan to implement automated operations for managing vehicle motion based in part on the slope of surrounding surfaces (such as from module 146h), and information 134i about a plan to implement automated operations for calibrating on-vehicle sensors based in part on sensor position and orientation (such as from module 146i). In this example, the earth-moving vehicle(s) 170/175/180 each has one or more LiDAR sensors 260 that generate data about a surrounding environment of the earth-moving vehicle(s) 170/175/180 (e.g., in the form of one or more 3D point clouds, not shown, and optionally after calibration operations are performed that provide LiDAR calibration data to translate the LiDAR data obtained from a current position of each LiDAR sensor to a global coordinate system for the site), one or more image sensors 250 of one or more cameras that generate visual data about a surrounding environment of the earth-moving vehicle(s) 170/175/180 (e.g., video, still images, etc., and optionally after calibration operations are performed that provide camera calibration data to translate the visual data obtained from a current position of each camera or other image sensor to a global coordinate system for the site), one or more infrared sensors 265 that generate infrared data about a surrounding environment of the earth-moving vehicle(s) 170/175/180 (e.g., for objects and other obstacles, etc., and optionally after calibration operations are performed that provide infrared calibration data to translate the infrared data obtained from a current position of each infrared sensor to a global coordinate system for the site), one or more pressure sensors 215 that provide data about when the attachment(s) are touching the ground or other underlying surface (based on pressure to the piston(s) or other cylinder(s) that lift the attachment, such as to detect when the attachment is on the surface based on the pressure going to zero or otherwise below a defined threshold such as 20 or 30 PSI, and optionally after calibration operations are performed that provide pressure sensor calibration data), one or more INS-DU or other IMU units to assist in determining vehicle position (e.g., with respect to orientation and in some cases position of the INS-DU or other IMU units, and optionally after calibration operations are performed that provide corresponding calibration data), and may optionally further have one or more other sensors 210, 220, 230, 235 or 245.

The model 128 may further be generated and deployed in the illustrated embodiment by the MPC-based Control System before its use by the EMVAOC system, including by its modules 161-163. In particular, module 161 may gather actual operational data 165 during at least some times (e.g., during manual control of the vehicle by one or more human operators), such as for manual control that includes performing one or more tasks during an ongoing operation session that occurs over an extended period of time (e.g., minutes, hours, etc.) and that results in actual operational data showing how the state of the vehicle and surrounding environment changes over time, and may supply that data to the module 163 as training data 136, optionally along with simulated operational data 160 and associated simulated updated digmap site map 131b from one or more operational data simulators 149 (e.g., for initial training before the model(s) are used; updated training while the model(s) are being used, such as to improve their performance over time; etc.)—the module 163 may initially generate one or more offline versions 128x of the model, before the module 162 later deploys a current copy of one of the model(s) 128 for use by the EMVAOC system. During operation, the actual operational environment data and other actual operational data 165 obtained by the on-vehicle sensors and resulting updated digmap site map 131a may similarly be provided to or otherwise accessed by the EMVAOC system 140. The EMVAOC system 140 may analyze the environment data and other data 165 from the vehicle(s) 170/175/180 to generate additional data (e.g., to classify types of obstacles of detected objects, to generate a terrain contour map or other visual map 131a of some or all of the surrounding environment, to determine prohibited 3D positions, etc.) and to determine operation control instructions to implement on the vehicle(s) 170/175/180 as discussed elsewhere herein (e.g., based on evaluation of candidate action sequences), including for vehicle motion between locations on a job site and for attachment movements as part of vehicle operations—for example, the EMVAOC system 140 may produce digmap information or other 2D or 3D site map representations 131a (not shown) to represent the terrain of some or all of the job site, such as for use by a planner module 147 and/or to further supply to the module 162 during the training phase; etc. As one non-exclusive example, the operation control instructions provided from the EMVAOC system 140 may simulate inputs to the control panel on a powered earth-moving vehicle that would be used by a human operator, if one were present, and translate the operation control instructions to implementation activities for the vehicle(s) 170/175/180 (e.g., hydraulic and/or electrical impulses that are provided to the vehicle(s) 170/175/180), optionally using one or more other trained models (not shown)—for example, a command may represent joystick deflection (e.g., for one or both of two joysticks, each with 2 axes), activation of a tool control button on one of the joysticks for controlling the tool attachment (e.g., claw, bucket, hammer, etc.), pedal position (e.g., for one or both of two pedals, analogous to car pedals but with a zero position in the middle and with the pedal able to move forward or backward), etc., such as using a number between −1 and 1, and such as by using one or more piston displacement mechanisms positioned to manipulate one or more controls of the powered earth-moving vehicle when actuated. In one embodiment, the behavioral model achieves at least 17% efficiency improvement and 20× duty cycle improvement over human operators and proportional fuel efficiency can also be achieved.

FIG. 2I further illustrates additional modules that may interact with the EMVAOC system 140 and/or each other to provide additional functionality. In particular, one or more users 150 may use one or more user interface(s) 153 (e.g., a GUI displayed on a computing device or provided via a VR and/or AR and/or mixed reality system) to perform one or more interactions, such as one or more of the following: to interact with a planner module 147 that computes an optimal or otherwise preferred plan for an entire job or to otherwise specify operational scenarios and receive simulated results, such as for use in determining optimal or otherwise preferred implementation plans to use for one or more tasks and/or multi-task jobs or to otherwise enable user what-if experimentation activities; to interact with a configuration determiner module 137 that uses the simulator module(s) 149 to determine optimal or otherwise preferred hardware component configurations to use and/or to generate simulated operational data 160 for use in model training; to interact with a simulator maintenance controller 133 to implement various types of maintenance activities; to directly supply human input for use by the simulator module(s) 149 (e.g., configuration parameters, settings, etc.); to request and receive visualizations of simulated operations and/or simulated operational data; etc. The planner module 147 may, for example, be independently developed through the design of artificial intelligence, and a plurality of plans from the planner module 147 may be input to the same trained model without having to train new models. In some embodiments, the simulator module(s) 149 may further generate rendered visualizations (e.g., using ‘unreal engine’ from Epic Games or another rendering engine).

FIG. 2J illustrates information 290j regarding physical movement dynamics information for an example powered earth-moving vehicle 170a/175a, which in this example is an excavator vehicle, such as may be used in the training and/or implementation of behavioral models 128, and/or by the operational data simulator module 149 in simulating operations of such an earth-moving vehicle, and/or as part of determining prohibited 3D positions for movement of the vehicle's hydraulic arms and tool attachment corresponding to other parts of the vehicle (e.g., the vehicle body, the tracks, etc.) and/or as part of determining positions of vehicle arm(s) and/or attachment(s) to use as part of operations related to balancing, slippage, controlled stoppage, etc. In this example, the information 290j illustrates angles and directions that arm(s)/attachment may move, such as for a bucket/scoop attachment in this example. In at least some such embodiments, the operational data simulator module may use various movement-related equations as part of its operations, such as to include the following:

$$Position$$

$$Derivative : r ( t )$$

$$Integral : r ( t ) = {r}_{0} + {\int }_{0}^{t} {vdt}^{′}$$

$$Velocity$$

$$Derivative : v ( t ) = \frac{\begin{matrix}dr \\ dt\end{matrix}}{\text{?}}$$

$$Integral : v ( t ) = {v}_{0} + {\int }_{0}^{t} {adt}^{′}$$

$$Acceleration$$

$$Derivative : a ( t ) = \frac{\begin{matrix}dv \\ dt\end{matrix}}{\text{?}} = \frac{\begin{matrix}d * d * r \\ d * t * t\end{matrix}}{\text{?}}$$

$$Integral : a ( t )$$

$$W = {\int }_{a}^{b} F ( x ) {d}^{x}$$

$$\text{?} \text{indicates text missing or illegible when filed}$$

Then composes to the full law of motion:

$$x ( t ) = {x}_{0} + {\int }_{n}^{t} v ( T ) dT = {x}_{0} + {\int }_{n}^{t} {v}_{0} {e}^{- \frac{k}{m} T} dT = {x}_{0} - m * {v}_{0} / k * ( {e}^{- \frac{k}{m} T} - 1 ) = {x}_{0} + m * {v}_{0} / k * ( 1 - {e}^{- \frac{k}{m} T} )$$

Forward Kinematics: This process transforms measured joint angles from a given origin to calculate positions of the end effectors (stick end and bucket bottom). It is a chain of transformations from the initial joint (cabin) up to the final effector (bucket).

Inverse kinematics: This process infers a possible set of joint angles to put the end effector (stick end or bucket end) to a specified position in the cylindrical space. It is handled by a custom Decision Tree-based machine learning model. To create training/test data for the model, a grid search of all possible angles for joints (between minimum and maximum limit of the joints) is used, and forward kinematics are computed to create ground truth labels. 20% of the data may be used for testing of the model, and 80% may be used for the training. During the inference, a destination position in cylindrical coordinates is provided to the model, and the model outputs the closest joint angles that will hold the effector in the desired destination position. As a safety mechanism, forward kinematics may be run one more time with the model outputs to verify the results in a real-time manner.

Joint Physics: Simulation of hydraulic physics may be calculated with state-based approximations, such as for the following example states:
1—Idle-no input is applied after SlowDown state is transitioned out completely (model assumes no movement in the joints);
2-WindUp—in seconds, time between start input and start of movement, with delay caused by the pilot hydraulics getting pressurized before opening valves on the main hydraulics;
3—SpeedUp—interpolation until speed reaches MaxAngularSpeed, to ease in to the target angular velocity, using a formula as follows:

Alpha=Clamp(timedelta,0.0,SpeedUpCoefficient)/SpeedUpCoefficient
InterpolationEaseOut(0.0,Desired Angular Velocity,Alpha,2.0);
4—Sustain-when input is stopped, until speed reaches 0, keeping steady at the target angular velocity;
5—SlowDown-ease out of the target angular velocity and ease in to zero, using a formula as follows:

Alpha=Clamp(timedelta,DesiredVelocityAtStart,SlowDownCoefficient)/SlowDownCoefficient
InterpolationEaseOut (0.0, Desired Angular Velocity, Alpha, 2.0).

Different Windup/SpeedUp/Sustain/SlowDown times may be used based on particular machines and conditions, such as for domain randomization. It will be appreciated that the operational data simulator module may use other equations in other embodiments, whether for earth-moving vehicles with the same or different attachments and/or for other types of earth-moving vehicles. In at least some embodiments, the operational data simulator module may, for example, simulate the effect of wet sand on the terrain. More generally, use of the operational data simulator module may perform experimentation with different alternatives (e.g., different sensors or other hardware components, component placement locations, hardware configurations, etc.) without actually placing them on physical earth-moving vehicles and/or for different environmental conditions without actually placing earth-moving vehicles in those environmental conditions, such as to evaluate the effects of the different alternatives and use that information to implement corresponding setups (e.g., to perform automated operations to determine what hardware components to install and/or where to install it, such as to determine optimal or near-optimal hardware components and/or placements; to enable user-driven operations that allow a user to plan out, define, and visualize execution of a job; etc.). Furthermore, such data from simulated operation may be used in at least some embodiments as part of training one or more behavioral machine learning models for one or more earth-moving vehicles (e.g., for one or more types of earth-moving vehicles), such as to enable generation of corresponding trained models and methodologies (e.g., at scale, and while minimizing use of physical resources) that are used for controlling autonomous operations of such earth-moving vehicles.

FIG. 2K illustrates further example information related to the gathering and generation of environment data, such as by perception system 141, and illustrates information 290k to provide non-exclusive examples of environment data that may be gathered and generated by an embodiment of the EMVAOC system 140. In this example, information 290k1 illustrates an example of an image of surrounding terrain that may be captured around a powered earth-moving vehicle (not shown), such as by one or more RGB cameras located on the vehicle. Information 290k2 illustrates an example of information that may be gathered by one or more LiDAR modules on the vehicle regarding part of a surrounding environment, such as to include 3D data points that illustrate shape and depth information for surrounding terrain, as well as objects in the environment (e.g., one or more vehicles, a person, a rock or other object, etc.). Information 290k3 illustrates a further example of a 3D point cloud that may be generated from LiDAR data, and shows depth and shape information for a surrounding environment, such as terrain of the environment. Information 290k4 illustrates one example of a visual map of a surrounding environment (e.g., a DigMap) that may be generated from such LIDAR data, which in this example is a terrain contour visual map. In at least some embodiments, such a visual map may include a set of 3D data points, such as to each have a corresponding XYZ coordinate in relation to an origin point (e.g., a location of a LiDAR component that is used to generate the 3D data points).

As one non-exclusive example embodiment, the MPC-based Control System is used with earth-moving vehicles that may operate in challenging environment conditions such as unpredictable weather and terrain movements, which can be significantly more challenging than environments used with traditional machine learning and deployment models where training and deployment can be readily accomplished in standalone manual cycles and deployment issues and bugs are handled via labor-intensive and time-consuming requirement-tracking systems, with such traditional issue-tracking solutions being inefficient and dangerous in earth-moving tasks where perceived topography is actively and constantly changing according to plan and/or environmental variations. Accordingly, the operations of the MPC-based Control System improve upon machine learning speed and operational safety.

In some situations in this one example embodiment, the one or more MPC Vehicle Operational Data Gatherer modules may include a perception module that obtains and uses data from a combination of sensors (e.g., one or more of LiDARs, imaging cameras, inclinometers, INS, pressure sensors, GPS, IMUs, GPS, and other sensors that collect perception data such as terrain composition, gradient, load, and obstacles), and an operator module that gathers human operator data such as control configurations and degree of control movements as well as machine data such as fuel consumption and pressure readings, such as while the vehicle operates and changes the topography of the environment. The MM Deployment module may redirect data collection to the MM Training module, and once model training is completed, perform the deployment of the trained MPC dynamics model and optionally additional software for performance of autonomous operations (e.g., the EMVAOC system) onto one or more vehicles as appropriate. During data gathering, gathered 3D data in various forms may be compiled into a digmap site map (e.g., as a compressed understanding of the terrain including millions of collected points in a simplified point cloud form), such as at least 20 times per second as the terrain changes to keep track of the current topography reality, and which is similarly provided to the MM Training module. The MM Training module may, for example, execute in the cloud with a live data feed from one or more earth-moving vehicles, and use a Model Predictive Control (MPC) architecture designed specifically for controlling earth-moving machines in an environment with unknown environment parameters to train the MPC dynamics model 128 (e.g., a neural network that infers the dynamics of the environment from data, acting as a dynamics model)—through iteration, the MM Training module optimizes the MPC dynamics model 128 to predict future states based on both sequences of vehicle actions and a history of the vehicle's state to perform tasks according to a plan to result in a planned digmap site map. The use of the trained MPC dynamics model 128 on particular vehicles for autonomous operations may further be turned on or off based on user preferences, such as by enabling all, some, or none of the features of the automated operations on the vehicle.

In this one example embodiment, training activities may begin with the installation of the perception module and operator module in a data collection phase, with the collected data fed to the MM Deployment module for processing and generation of AI-processed analytics (e.g., including automated identification of areas for improvements) in an analytics phase and further used to train the MPC dynamics model in a training phase. These three phases operate iteratively without deployment until a determination is made to complete training and/or to deploy the trained MPC predictive dynamics models on one or more particular powered earth-moving vehicles, at which time corresponding deployment is performed. The MPC dynamics model may be trained for earth-moving tasks that include, for example, slot-dozing, production dozing, reclamation tasks, dealing with faults (e.g., misplaced materials), near-miss and other safety incidents, truck loading, trenching, scraping, loading, and general earth-moving tasks, and providing for a deep understanding of the variation of vehicles of a given type to provide for predictive maintenance and incident pre-emption.

In this one example embodiment, additional advances of these techniques may include the following: avoiding cold start issues in robotics by decomposing training and deployment into a structured series of steps, allowing for easier learning of mixed operation and safer model training; promote federated learning across vehicles owned and/or operated by multiple entities, such as with entity-specific data kept private and confidential in local training scenarios, while non-confidential data is shared to enable larger learning for the same type of vehicle across different sites; use the iterative process to self-check consistency in data from multiple sensors (e.g., perception data from a LIDAR and from a camera); provide a failsafe in semi-autonomous operations to prevent human operator mistakes (e.g., even if fully autonomous operations have not been deployed), such as to remove humans and other environmental elements from harm; etc.

The EMVAOC system may further perform additional automated operations in at least some embodiments as part of determining a motion/movement plan that includes a powered earth-moving vehicle motion from a current location to one or more target destination locations, with non-exclusive examples including the following: having the powered earth-moving vehicle create a road (e.g., by flattening or otherwise smoothing dirt or other materials of the terrain between the locations) along a selected path as part of the motion/movement plan, including to optionally select that path from multiple alternative paths based at least in part on a goal involving creating such a road at such a location; considering environmental conditions (e.g., terrain that is muddy or otherwise slick/slippery due to water and/or other conditions), including in some embodiments and situations to adjust classifications of some or all obstacles in an area between the current and target destination locations to reflect those environmental conditions (e.g., temporarily, such as until the environmental conditions change); considering operating capabilities of that particular vehicle and/or of a type of that particular vehicle (e.g., tool attachments, size, load weight and/or material type limits or other restrictions, etc.), including in some embodiments and situations to adjust classifications of some or all obstacles in an area between the current and target destination locations to reflect those operating capabilities (e.g., temporarily, such as for planning involving that particular vehicle and/or vehicle type); using motion/movement of some or all of the vehicle to gather additional data about the vehicle's environment (e.g., about one or more possible or actual obstacles in the environment), including in some embodiments and situations to adjust position of a moveable component part of the vehicle (e.g., hydraulic arm, tool attachment, etc.) on which one or more sensors are mounted to enable gathering of the additional data, and/or to move a location of the vehicle to enable one or more sensors that are mounted at fixed and/or moveable positions to gather the additional data; performing obstacle removal activities for an obstacle that include a series of actions by one or more powered earth-moving vehicles, such as involving moving a large pile of dirt (e.g., requiring numerous scoops, pushes or other actions), flattening or otherwise leveling some or all of a path (e.g., digging through a hill or other projection of material, filling a hole or ravine or other cavity, etc.); etc.

The EMVAOC system may perform other automated operations in at least some embodiments, with non-exclusive examples including the following: tracking motion/movement of one or more obstacles (e.g., people, animals, vehicles, falling or sliding objects, etc.), including in response to instructions from the EMVAOC system for those obstacles to move themselves and/or to be moved; tracking objects on some or all of a job site as part of generating analytics information, such as using data from a single powered earth-moving vehicle on the site or by aggregating information from multiple such earth-moving vehicles, including information of a variety of types (e.g., about a number of vehicles of one or more types that are currently on the site or have passed through it during a designated period of time; about a number of people of one or more types, such as workers and/or visitors, that are currently on the site or have passed through it during a designated period of time; about activities of a particular vehicle and/or a particular person at a current time and/or during a designated period of time, such as vehicles and/or people that are early or late with respect to a defined time or schedule, identifying information about vehicles and/or people such as license plates or RFID transponder IDs or faces or gaits; about other types of site activities, such as material deliveries and/or pick-ups, task performance, etc.); etc.

The EMVAOC system may further perform additional automated operations in at least some embodiments as part of determining a motion/movement plan that includes powered earth-moving vehicle motion from a current location to one or more target destination locations, with non-exclusive examples including the following: having the powered earth-moving vehicle create a road (e.g., by flattening or otherwise smoothing dirt or other materials of the terrain between the locations) along a selected path as part of the motion/movement plan, including to optionally select that path from multiple alternative paths based at least in part on a goal involving creating such a road at such a location; considering environmental conditions (e.g., terrain that is muddy or otherwise slick/slippery due to water and/or other conditions), including in some embodiments and situations to adjust classifications of some or all obstacles in an area between the current and target destination locations to reflect those environmental conditions (e.g., temporarily, such as until the environmental conditions change); considering operating capabilities of that particular vehicle and/or of a type of that particular vehicle (e.g., tool attachments, size, load weight and/or material type limits or other restrictions, etc.), including in some embodiments and situations to adjust classifications of some or all obstacles in an area between the current and target destination locations to reflect those operating capabilities (e.g., temporarily, such as for planning involving that particular vehicle and/or vehicle type); using motion/movement of some or all of the vehicle to gather additional data about the vehicle's environment (e.g., about one or more possible or actual obstacles in the environment), including in some embodiments and situations to adjust position of a moveable component part of the vehicle (e.g., hydraulic arm, tool attachment, etc.) on which one or more sensors are mounted to enable gathering of the additional data, and/or to move a location of the vehicle to enable one or more sensors that are mounted at fixed and/or moveable positions to gather the additional data; performing obstacle removal activities for an obstacle that include a series of actions by one or more powered earth-moving vehicles, such as involving moving a large pile of dirt (e.g., requiring numerous scoops, pushes or other actions), flattening or otherwise leveling some or all of a path (e.g., digging through a hill or other projection of material, filling a hole or ravine or other cavity, etc.); etc.

The EMVAOC system may perform other automated operations in at least some embodiments, with non-exclusive examples including the following: tracking motion/movement of one or more obstacles (e.g., people, animals, vehicles, falling or sliding objects, etc.), including in response to instructions from the EMVAOC system for those obstacles to move themselves and/or to be moved; tracking objects on some or all of a job site as part of generating analytics information, such as using data from a single powered earth-moving vehicle on the site or by aggregating information from multiple such earth-moving vehicles, including information of a variety of types (e.g., about a number of vehicles of one or more types that are currently on the site or have passed through it during a designated period of time; about a number of people of one or more types, such as workers and/or visitors, that are currently on the site or have passed through it during a designated period of time; about activities of a particular vehicle and/or a particular person at a current time and/or during a designated period of time, such as vehicles and/or people that are early or late with respect to a defined time or schedule, identifying information about vehicles and/or people such as license plates or RFID transponder IDs or faces or gaits; about other types of site activities, such as material deliveries and/or pick-ups, task performance, etc.); etc.

Various details have been provided with respect to FIGS. 2A-2K, but it will be appreciated that the provided details are non-exclusive examples included for illustrative purposes, and other embodiments may be performed in other manners without some or all such details. For example, multiple types of sensors may be used to provide multiple types of data and the multiple data types may be combined and used in various ways in various embodiments, including non-exclusive examples of magnetic sensors and/or IMUs (inertial measurement units) to measure position data and whether in addition to or instead of the use of GPS and inclinometer data.

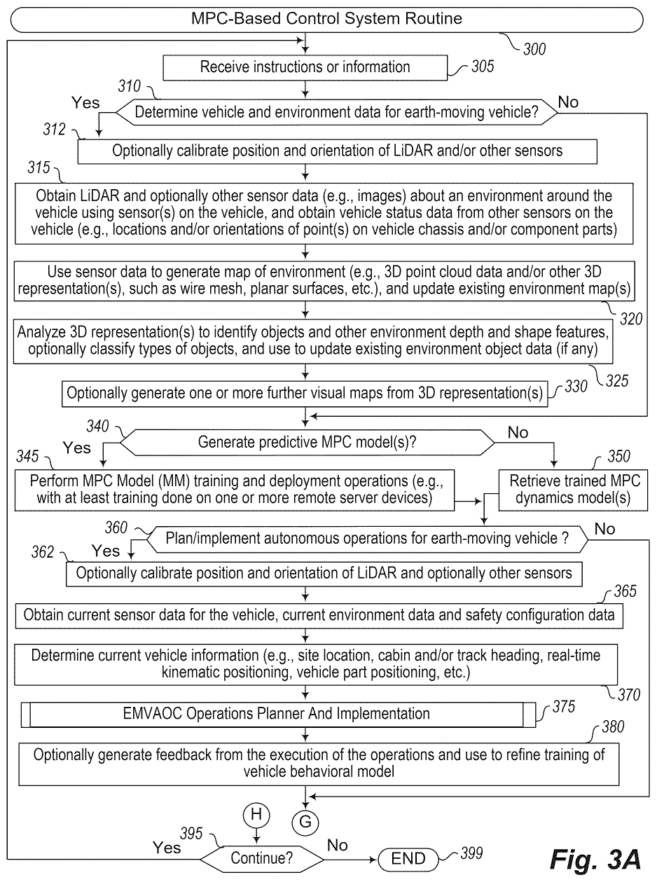

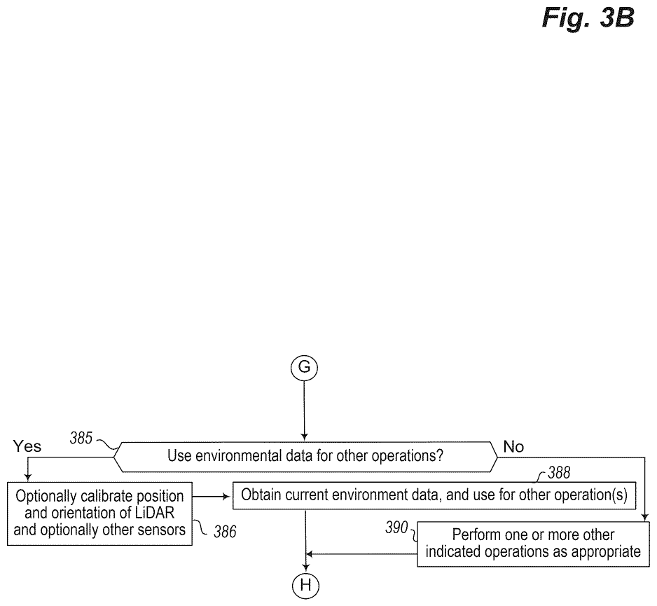

FIGS. 3A-3B are an example flow diagram of an illustrated embodiment of an MPC-based Control System routine 300. The routine may be provided by, for example, execution of an embodiment of the MPC-based Control System 295 of FIGS. 1A-1B and/or the MPC-based Control System discussed with respect to FIGS. 2A-2K and elsewhere herein, such as to perform a computer-implemented method to provide automated operations for implementing autonomous control of powered earth-moving vehicles, including to automatically control movement of some or all of one or more powered earth-moving vehicles on a job site using one or more such trained predictive dynamics models (e.g., a trained MPC dynamics model specific to the vehicle and/or vehicle type) to perform tasks while conforming with specified safety rules or other specified safety configuration data. While routine 300 is discussed with respect to controlling operations of a single powered earth-moving vehicle at a time, it will be appreciated that the routine 300 may be performed in other manners in other embodiments, including to control operations of multiple powered earth-moving vehicles of one or more types on a job site, to be implemented by one or more configured devices or systems (optionally in multiple locations and/or operating in a distributed or otherwise coordinated manner, such as with a computing device local to a powered earth-moving vehicle performing some of the automated operations while one or more separate server systems in communication with that computing device perform additional portions of the routine), etc.

The routine 300 begins in block 305, where instructions or other information are received (e.g., waiting at block 305 until such instructions or other information is received). The routine continues to block 310 to determine whether the instructions or information received in block 305 indicate to currently determine vehicle and environmental perception data for an earth-moving vehicle (e.g., using LIDAR sensors and/or image sensors and optionally other sensors located on the vehicle) and if so continues to perform blocks 312-330—in at least some embodiments, sensor data may be gathered repeatedly (e.g., continuously), and if so at least block 315 may be performed for each loop of the routine and/or repeatedly while the routine is performing other activities or otherwise waiting (e.g., at block 305) to perform other activities. In block 312, the routine in this example embodiment performs automated operations to calibrate the position and orientation of one or more sensors to be used to gather the environment data, such as for each of one or more LiDAR sensors and/or one or more image sensors (e.g., as part of one or more cameras) and/lor one or more infrared sensors—the calibration of each sensor may include determining a current position and orientation of the sensor relative to one or more points on the vehicle used as the basis for a global coordinate system relative to and extending from the point(s), or relative to one or more points on the vehicle having known location(s) in an absolute global coordinate system. As discussed in greater detail elsewhere herein, the calibration of each sensor may include obtaining multiple data sets from the sensor (e.g., 3D point clouds from a LIDAR sensor) with significant overlap from the same vehicle location but with small differences in orientation of the vehicle and/or of the sensor (e.g., by changing orientation of a movable vehicle part on which the sensor is located, by changing orientation of the vehicle body on which the sensor is located, etc.), analyzing pairs of datasets to determine parameters that maximize overlap between the datasets in the global coordinate system, and using an ICP (iterative closest point) algorithm to refine the parameters in order to determine a best match between data points in the pair of datasets. In block 315, the routine in this example embodiment then obtains LIDAR data and optionally other sensor data (e.g., one or more images) for an environment around the powered earth-moving vehicle using sensors positioned on the vehicle and optionally additional other sensors on or near the vehicle (e.g., for multiple powered earth-moving vehicles on a job site to share their respective environment data, whether in a peer-to-peer manner directly between two or more such vehicles, and/or by aggregating some or all such environment data in a common storage location accessible to some or all such vehicles), and with obtained data converted into a global coordinate system based in part on determined calibration data. In block 320, the routine then uses the sensor data to generate site map data, such as a 3D point cloud data and optionally one or more other 3D representations of the environment (e.g., using wire mesh, planar services, voxels, etc.), for example in the global coordinate system, and uses the generated 3D representation(s) to update other existing environment data (if any). As discussed in greater detail elsewhere herein, such sensor data may be gathered repeatedly (e.g., continuously), such as in a passive manner for whatever direction the sensor(s) on the vehicle are currently facing and/or in an active manner by directing the sensors to cover a particular area of the environment that is of interest (including moving component parts of the vehicle on which the sensors are mounted or otherwise attached to move the sensors to new location and orientation poses from which additional data may be obtained), optionally with new calibration performed for each change in position of the sensor relative to the point(s) on the vehicle used for the global coordinate system (e.g., if mounted on a movable component part of the vehicle that has been moved), and environment information from different scans of the surrounding environment may be aggregated in the global coordinate system as data from new areas becomes available and/or to update previous data for an area that was previously scanned. In block 325, the routine then continues to analyze the 3D representation(s) to identify objects and other environment depth and shape features, to classify types of the objects as obstacles with respect to operations of the vehicle, and to update other existing information about such objects (if any), and in block 330 optionally generates one or more further visual maps from the 3D representation(s). As discussed in greater detail elsewhere herein, such obstacle data and other object data may be used in a variety of manners, including by a planner module to determine autonomous operations for the vehicle to perform.

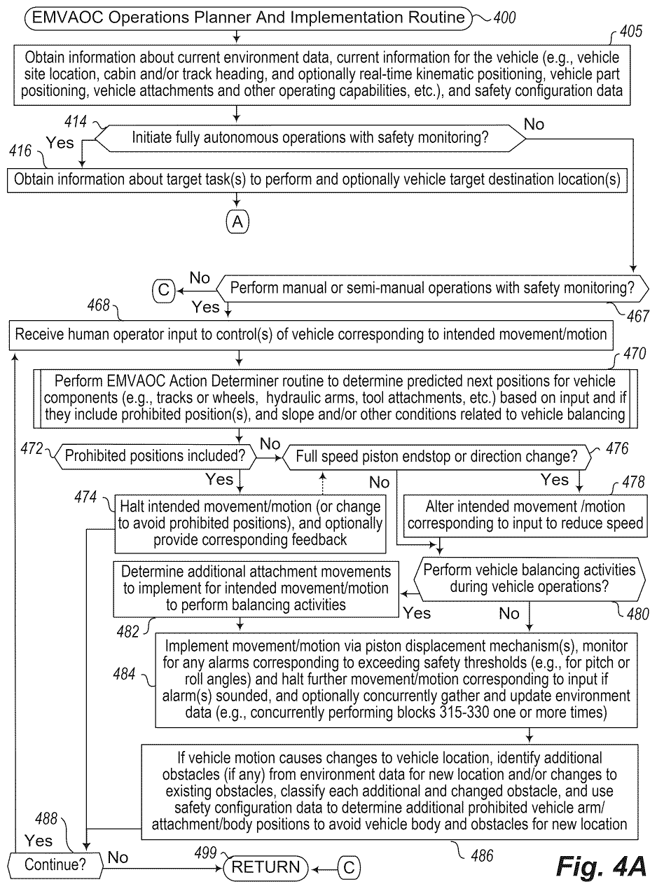

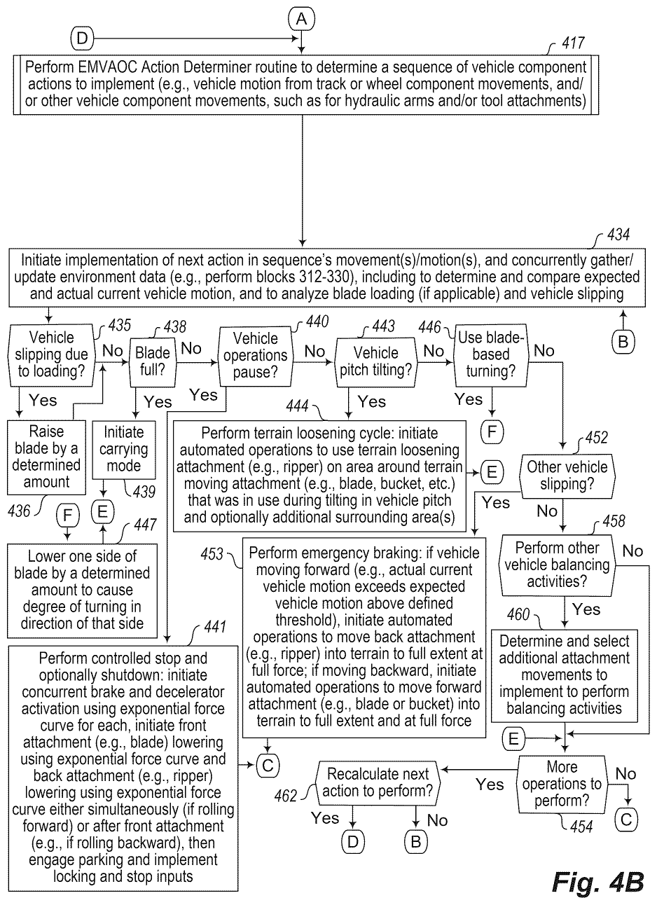

After block 330, or if it is instead determined in block 310 that the instructions or information received in block 305 do not indicate to currently determine vehicle and environment data for an earth-moving vehicle, the routine 300 continues to block 340 to determine whether the instructions or other information received in block 305 indicate to generate one or more predictive dynamics models for the vehicle (e.g., one or more trained MPC dynamics models), and if so continues to block 345 to perform model training and deployment operations, and otherwise continues to block 350 to retrieve a previously trained model (e.g., an MPC predictive dynamics model stored on the vehicle). After blocks 345 or 350, the routine continues to block 360 to determine whether the instructions or information received in block 305 indicate to use a trained predictive dynamics model to plan and implement autonomous operations of one or more earth-moving vehicles involving vehicle motion and/or tool attachment movement of some or all of one or more powered earth-moving vehicles on a job site to conform with specified safety rules or otherwise satisfy specified criteria, such as while performing one or more tasks and/or multi-task jobs (e.g., to identify one or more target destination locations and optionally tasks to be performed as part of vehicle motion to reach the target destination location(s), such as to create roads along particular paths and/or to remove particular obstacles), and including using environment data for the vehicle (e.g., data just determined in blocks 312-330), and if so continues to perform blocks 362-380 to perform the autonomous operations control. In block 362, the routine optionally performs automated operations to calibrate the position and orientation of one or more sensors to be used to gather the environment data, such as in a manner similar to block 312, and to be performed if the position of the sensor relative to the point(s) on the vehicle used for the global coordinate system has changed since a last calibration (e.g., since block 312 and/or 362 was previously performed) or if a previous calibration was not performed. In block 365, the routine obtains current status information for the earth-moving vehicle(s) (e.g., sensor data for the earth-moving vehicle(s)), current environment data for the vehicle(s), and safety configuration data and/or other specified criteria to use (e.g., as received in block 305, as retrieved from storage, etc.), and with obtained data converted into a global coordinate system based in part on determined calibration data. After block 365, the routine continues to block 370, where it determines information about the earth-moving vehicle (e.g., one or more of the earth-moving vehicle's on-site location, real-time kinematic positioning, cabin and/or track heading, positioning of other component parts of the earth-moving vehicle such as the arm(s)/bucket, particular tool attachments and/or other operational capabilities of the vehicle, etc.). In block 375, the routine then submits input information to an EMVAOC Operations Planner And Implementation subroutine to determine one or more movement/motion plans to be implemented in light of the safety configuration data and/or other specified criteria and optionally one or more tasks and/or jobs to perform, and to implement the movement/motion plan operations by the earth-moving vehicle(s) to perform the one or more tasks—one example of such a subroutine is discussed in greater detail with respect to FIGS. 4A-4B. After block 375, the routine in block 380 optionally generates feedback from the execution of the operations for use in subsequent refinement of the earth-moving vehicle behavioral model's training.

After block 380, or if it is instead determined in block 360 that the information or instructions received in block 305 are not to plan and implement automated operations of earth-moving vehicle(s), the routine continues to block 385 to determine if the information or instructions received in block 305 are to use environment data for other purposes (e.g., for environment data just generated in blocks 312-330), and if so the routine continues to block 386. In block 386, the routine optionally performs automated operations to calibrate the position and orientation of one or more sensors to be used to gather the environment data, such as in a manner similar to blocks 312 and/or 362, and to be performed if the position of the sensor relative to the point(s) on the vehicle used for the global coordinate system has changed since a last calibration (e.g., since block 312 and/or 362 and/or 386 was previously performed) or if a previous calibration was not performed. In block 388, the routine then obtains current environment data, with obtained data converted into a global coordinate system based in part on determined calibration data, and uses the environment data to perform one or more additional types of automated operations-non-exclusive examples of such additional types of automated operations include the following: tracking movement of one or more obstacles (e.g., people, animals, vehicles, falling or sliding objects, etc.), including in response to instructions issued by the MPC-Based Control system for those obstacles to move themselves and/or to be moved; generating analytics information, such as tracking objects on some or all of a job site using data only from the earth-moving vehicle or by aggregating information from data from the earth-moving vehicle with data from one or more other earth-moving vehicles (e.g., about locations and/or activities of one or more other vehicles and/or people); etc.

If it is instead determined in block 385 that the information or instructions received in block 305 are not to use environment data for other purposes, the routine continues instead to block 390 to perform one or more other indicated operations as appropriate, such as if so indicated in the instructions or other information received in block 305. For example, the operations performed with respect to block 390 may include receiving and storing data and other information for subsequent use (e.g., safety configuration data, including thresholds and other settings to use; other specified criteria to be satisfied during automated operations of the MPC-Based Control System; actual and/or simulated operational data; sensor data; an overview workplan and/or other goals to be accomplished, such as for the entire project, for a day or other period of time, and optionally including one or more tasks to be performed; etc.), receiving and storing information about earth-moving vehicles on the job site (which vehicles are present and operational, status information for the vehicles, etc.), receiving and responding to requests for information available to the MPC-Based Control System (e.g., for use in a displayed GUI to an operator user that is assisting in activities at the job site and/or to an end user who is monitoring activities), receiving and storing instructions or other information provided by one or more users and optionally initiating corresponding activities, etc. While not illustrated here, in some embodiments the routine may perform further interactions with a client or other end user, such as before, during or after receiving or providing information in block 390, as discussed in greater detail elsewhere herein. In addition, it will be appreciated that the routine may perform operations in a synchronous and/or asynchronous manner.

After blocks 388 or 390, the routine continues to block 395 to determine whether to continue, such as until an explicit indication to terminate is received, or instead only if an explicit indication to continue is received. If it is determined to continue, the routine returns to block 305 to wait for additional information and/or instructions, and otherwise continues to block 399 and ends.

FIGS. 4A-4B are an example flow diagram of an illustrated embodiment of an EMVAOC (Earth-Moving Vehicle Autonomous Operations Control) Operations Planner And Implementation routine 400. The routine may be provided by, for example, execution of an embodiment of the EMVAOC system 140 (e.g., of modules 147 and/or 144 and/or 146e and/or 146f and/or 146g and/or 146h and/or 146i) of FIGS. 1A-1B and/or the EMVAOC system discussed with respect to FIGS. 2A-2K and elsewhere herein, such as to perform a computer-implemented method to provide automated operations related to determining tasks to perform and determining additional operations to implement as part of such task performance if specified conditions occur and/or specified criteria are satisfied (e.g., related to controlling vehicle steering using a blade tool attachment), including analyzing information about an environment of a powered earth-moving vehicle and determining corresponding information (e.g., slopes and other non-level surfaces, potential obstacles, classifications of the types of the obstacles, etc.), and determining how to accomplish a goal that includes controlling vehicle motion and/or tool attachment movement of one or more powered earth-moving vehicles on a job site (e.g., optionally including moving a powered earth-moving vehicle from its current location to a determined target destination location, and handling any possible obstacles between the current and destination locations) in accordance with specified safety rules or other specified criteria (e.g., to avoid prohibited 3D positions, to reduce or eliminate vehicle slippage and tilting, etc.). The routine 400 may be invoked in various manners, including in block 375 of the EMVAOC System routine 300 as discussed in FIGS. 3A-3B, and if so may return to that invocation location after the routine returns. While routine 400 is discussed with respect to controlling operations of a single powered earth-moving vehicle at a time, it will be appreciated that the routine 400 may be performed in other manners in other embodiments, including to control operations of multiple powered earth-moving vehicles of the same type and/or multiple types on a job site, to be implemented by one or more configured devices or systems (optionally in multiple locations and/or operating in a distributed or otherwise coordinated manner, such as with a computing device local to a powered earth-moving vehicle performing some of the automated operations while one or more separate server systems in communication with that computing device perform additional portions of the routine), to separate the operations related to object determination and classification from those related to motion and movement planning (e.g., to be executed at different times), etc.

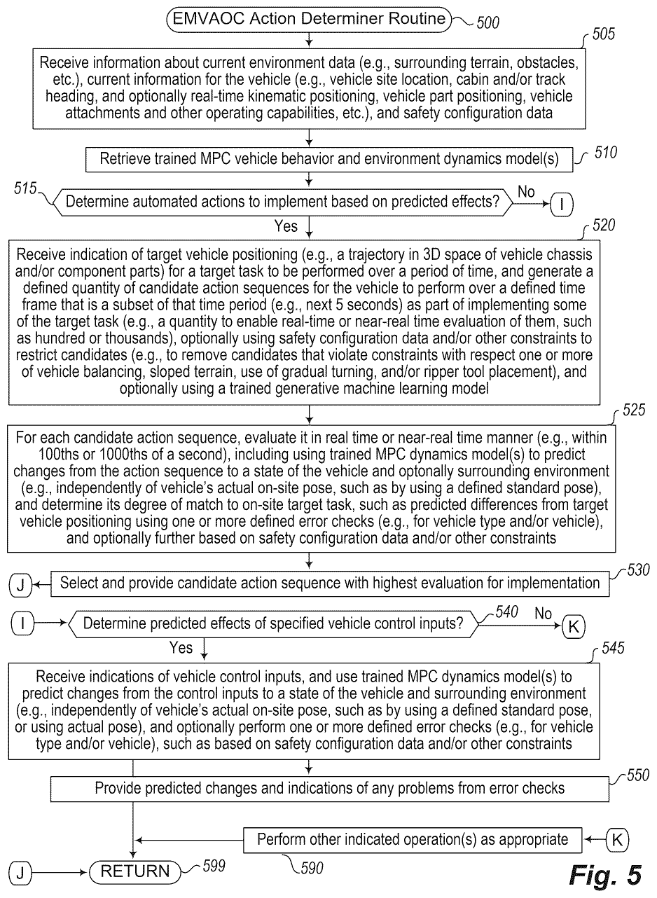

The routine begins in block 405, where it obtains information that includes current information about a powered earth-moving vehicle (e.g., vehicle location and positioning for various component parts of the vehicle, operating capabilities for the vehicle, etc.), current environment data for an area around the vehicle, and specified criteria to be used (e.g., safety-related criteria), and with obtained data converted into a global coordinate system based in part on determined calibration data. After block 405, the routine continues to block 414, where it determines whether to implement fully autonomous operations, and if not proceeds to block 467. If it is determined to implement fully autonomous operations, the routine continues to block 416, where it obtains information about one or more tasks to be performed, optionally along with one or more target destination locations and/or orientations/directions different from a current location and orientation/direction of the vehicle, and with the task(s) to be performed at the current originating location and/or at the target destination location(s) and/or at one or more intermediate locations between the originating and destination locations—as discussed in greater detail elsewhere herein, such task information may include one or more target trajectories each having a path in 3D space to be followed by an indicated point on a vehicle body or component part. In block 417, the routine then performs an EMVAOC Action Determiner module routine to determine a particular action sequence to implement to perform at least a next subset of the task(s), such as to correspond to a portion of the target trajectories for a short time interval that is a subset of an overall period of time to perform the task(s)—one example of such a subroutine is discussed in greater detail with respect to FIG. 5.

After block 417, the routine continues to block 434 to implement a next action in the determined action sequence (beginning with the first action), including to gather and update data about the vehicle and the environment during the implementation of the selected action and corresponding vehicle motion(s) and/or movement(s), such as by performing operations corresponding to some or all of blocks 312-330 of FIGS. 3A-3B, including calibrating one or more sensors to be used in gathering data about the vehicle and environment—initial vehicle motion(s) and/or attachment movement(s) that are selected may correspond to an amount of time (e.g., 1 second, 5 seconds, 1 minute, etc.), some or all of a subtask (e.g., a movement of a hydraulic arm, a movement of one or more wheels or tracks, etc.), etc.

The routine then proceeds to perform blocks 435-462 as part of further monitoring during the implementation of the movement/motion for the selected action. In particular, in block 435 the routine determines whether the vehicle is estimated to be experiencing slipping due to loading of a blade tool attachment (e.g., based on monitoring as performed in block 434 and/or in an ongoing manner), and if so proceeds to block 436 to raise the blade tool by a determined amount to reduce friction caused by the material being moved by the blade tool—as discussed in greater detail elsewhere herein, the determination of whether the vehicle is estimated to be experiencing slipping may be based at least in part on output of a trained machine learning model that takes as input various parameters about performance of the vehicle and optionally additional input data about the blade tool attachment and its loading. After block 436, or if it is instead determined in block 435 that the vehicle is not estimated to be slipping due to loading of the blade tool attachment, the routine continues to block 438 to determine if a blade tool attachment is estimated to be full (or to otherwise have loading above a defined threshold) during pushing/cutting/loading operations of a pushing/cutting/loading mode, and if so continues to block 439 to initiate a switch to a carrying mode that includes lifting the blade tool attachment about the surface of the terrain and materials that were being pushed/cut/loaded—as discussed in greater detail elsewhere herein, the determination of whether the blade tool is estimated to be full may be based at least in part on output of a trained machine learning model that takes as input various parameters about performance of the vehicle and optionally additional input data about the blade tool attachment and its loading. After block 439, the routine continues to block 454.

If it is instead determined in block 438 that a blade tool attachment is not estimated to be full, the routine continues instead to block 440 to determine whether to pause vehicle operations and perform a controlled stop to vehicle operations and optional subsequent vehicle shutdown—such a pause in vehicle operations may be included as part of the movement/motion plan being implemented, and/or may be determined based on current conditions (e.g., an instruction received from a human operator, if the vehicle is nearly out of fuel or is overheating or another fault occurs, if continued operations would interfere with another vehicle and/or person, or if one or more other specified pause criteria are satisfied). If so, the routine continues to block 441 to perform the controlled stop to vehicle operations and optional subsequent vehicle shutdown, such as by initiating concurrent brake and decelerator activation (e.g., using a separate exponential force curve for each), subsequently initiating (e.g., at a specified time during or after the brake and decelerator activation) lowering of the front attachment (e.g., a blade or bucket) into the terrain (e.g., using an exponential force curve), and initiating lowering of the back attachment (e.g., a ripper) into the terrain (e.g., using an exponential force curve) either simultaneously with the front attachment (e.g., if the vehicle is rolling forward) or after the front attachment lowering has begun and optionally has completed (e.g., if the vehicle is rolling backward). After the vehicle is stationary and the vehicle tool attachment(s) movements have stopped, the operations then include engaging the vehicle parking, and optionally then performing locking activities and/or stopping inputs to the vehicle controls. After block 441, the routine continues to block 499 and returns.

If it is instead determined in block 440 not to pause vehicle operations, the routine continues to block 443 to determine whether the vehicle pitch has unplanned tilting relative to the terrain slope and/or tool attachments in use, such as if the front of the tracks or front wheels are lifting off the terrain due to use of the front tool attachment (e.g., using a blade or bucket or ripper to push through terrain or other otherwise push materials), or if the back of the tracks or back wheels are lifting off the terrain due to use of the back tool attachment (e.g., using a blade or bucket or ripper to push through terrain or other otherwise push materials). If so, the routine continues to block 444 to perform a terrain loosening cycle, such as by using one or more tool attachments (e.g., a ripper) to perform terrain loosening by breaking up or tearing through or otherwise loosening the terrain in an area that includes where the front or back tool attachments were working when the vehicle pitch tilting occurred, and optionally around additional areas (e.g., around some or all of the current location of the vehicle). After block 444, the routine continues to block 454. If it is instead determined in block 443 that the vehicle is not having unplanned tilting, the routine continues to block 446 to determine whether to use a blade tool attachment to assist in vehicle turning or other steering (e.g., during forward vehicle motion with the blade tool attachment in use for material pushing/cutting/loading), such as if use of the tracks and/or wheels of the vehicle are not sufficiently maintaining the vehicle motion along a desired path, and if so continues to block 447 to determine a direction in which to correct the vehicle motion to return toward the desired path and to lower the blade tool attachment on the side of the determined direction (and/or to raise the blade tool attachment on the opposite side) while continuing the forward motion—in at least some embodiments and situations, the blade tool side lowering and/or raising may be performed in small increments with associated monitoring (e.g., after each increment, continuously or substantially continuously, etc.) to determine an aggregate effect of the one or more lowering and/or raising increments, such as to continue until a desired direction is reached or vehicle's path is otherwise corrected. After block 447, the routine continues to block 454.

If it is instead determined in block 446 to not use blade-based steering to fully perform or partially assist in vehicle turning, the routine continues instead to block 452 to determine whether the vehicle and/or environment data gathered in block 434 indicates that the vehicle is slipping for one or more other reasons (e.g., due to a sloped and/or slick surface), and if so proceeds to block 453 to initiate corrective slippage-related activities, such as to perform automated emergency braking operations. The emergency braking operations may include determining whether the vehicle is slipping forwards or backwards, and using different vehicle tool attachments accordingly if the vehicle has both one or more front tool attachments (e.g., a bucket or blade) and one or more rear tool attachments (e.g., a ripper with one or more teeth)—if the vehicle has a mid-vehicle tool attachment (e.g., a main blade on a grader), it may be used as a front tool attachment if the vehicle has a back tool attachment but no other front tool attachment, as a back tool attachment if the vehicle has a front tool attachment but no other back tool attachment, or as neither or both if the vehicle has other front and back tool attachments (e.g., a grader vehicle). After block 453, the routine continues to block 499 and returns.

If it is instead determined in block 452 that the vehicle is not slipping for other reasons such as due to a sloped and/or slick surface, the routine continues to block 458 to determine whether to perform other vehicle balancing-related activities during vehicle operations for the movement/motion plan, such as based at least in part on the determined slope and/or other determined conditions related to vehicle balancing, and if so continues to block 460 to determine additional attachment movements and/or other changes to implement for the selected movement/motion plan to perform the balancing activities. After block 460, or if it is instead determined in block 458 to not perform vehicle balancing activities, or after blocks 439 or 444 or 447, the routine continues to block 454 to determine whether there are more operations to perform for the current task, and if not proceeds to block 499 and returns, and otherwise continues to block 462 to determine whether to recalculate a next action to perform for the current selected action sequence (e.g., to always do so, to do so based on changes to the current action performed in blocks 435-460, etc.). If so, the routine returns to block 417 to determine a new action sequence to implement, and otherwise returns to block 434 to implement a next action for the current selected action sequence.

If it is instead determined in block 414 to not implement fully autonomous operations, the routine continues instead to block 467 to determine whether to instead implement safety monitoring operations in a semi-autonomous manner that is based in part on input from at least one human operator, and if not proceeds to block 499—in other embodiments and situations, only one of fully autonomous and semi-autonomous operations may be performed. If it is determined to implement safety monitoring operations in a semi-autonomous manner, the routine proceeds to block 468 to wait for and receive human operator input to one or more controls of the vehicle corresponding to intended vehicle motion and/or attachment movement. In block 470, the routine then performs the EMVAOC Action Determiner module routine to determine predicted next positions for the vehicle components/parts based on the input (e.g., in a real-time or near-real-time manner, such as within microseconds or milliseconds or centiseconds or deciseconds or seconds), as well as whether any of the predicted next positions involve any prohibited 3D positions—one example of such a routine is illustrated in FIG. 5. If it is determined in block 472 that one or more prohibited 3D positions will be included (including any slopes exceeding a defined threshold), the routine continues to block 474 to halt the intended movement/motion corresponding to the input and optionally provide corresponding feedback to the human operator, and then proceeds to block 488—in other embodiments and situations, rather than halting the intended movement/motion, the routine may instead determine an alternative movement/motion to implement that avoids the prohibited 3D positions while reaching the same destination or otherwise achieving the same result as much as possible, and if so may instead change the movement/motion to that alternative movement/motion and proceed to block 476, or instead may alert a human operator that the human operator input to one or more controls of the vehicle will include one or more prohibited 3D positions to enable the human operator to modify the input to the controls accordingly. If it is instead determined in block 472 that the intended movement/motion does not include any prohibited 3D positions (or an alternative movement/motion is determined in block 474), the routine continues instead to block 476 to determine whether the intended movement/motion involves moving a piston for a piston displacement mechanism to its endstop position at full speed (and optionally in some embodiments making an abrupt change from full speed movement of a movable vehicle part in one direction to a substantially opposite direction), and if so continues to block 478 to automatically alter the intended movement/motion to reduce the speed as the endstop position (or position of other abrupt change) is reached, although in some embodiments such checking may not be performed or may be overridden (e.g., if an operator user wants to shake material out of a bucket or other tool attachment)—in other embodiments and situations, rather than automatically reducing the speed, the routine may instead alert a human operator that the human operator input to one or more controls of the vehicle involves moving a piston for a piston displacement mechanism to its endstop position at full speed or to full-speed changing of direction of one or more arms and/or tool attachments to enable the human operator to modify the input to the controls accordingly if appropriate.

If it is instead determined in block 476 that the intended movement/motion does not involve reaching a piston endstop position (or direction change location) at full speed, or after block 478, the routine continues instead to block 480 to determine whether to perform vehicle balancing activities during vehicle operations for the movement/motion, such as based at least in part on the determined slope and/or other determined conditions related to vehicle balancing, and if so continues to block 482 to determine additional attachment movements and/or other changes to implement for the movement/motion to perform the balancing activities. After block 482, or if it is instead determined in block 480 to not perform vehicle balancing activities (e.g., due to the vehicle motion not involving any slopes above a defined minimum threshold or otherwise associated with balancing), the routine continues to block 484, where it implements the movement/motion corresponding to the input (and as optionally modified in blocks 474 and/or 478 and/or 482) using one or more piston displacement mechanisms, monitors for any alarms corresponding to exceeding safety thresholds during the movement (e.g., based on pitch and/or roll angles exceeding defined thresholds, such as corresponding to unplanned vehicle pitch tilting and/or yaw tilting and/or roll tilting; based on unplanned slippage on a sloped and/or slick surface; based on conditions to cause controlled stoppage of the vehicle, etc.), and halts further movement (or otherwise takes corrective action) if one or more such alarms are sounded. In at least some embodiments and situations, the performance of block 484 may further include gathering and updating additional environment data that is used during the implementing of the movement (e.g., by concurrently performing some or all of blocks 312-330 one or more times, including optional automated calibration of one or more sensors to be used for gathering data about the environment and/or vehicle). In at least some embodiments and situations, the routine may further store information about manual inputs supplied to vehicle controls and of resulting vehicle and/or environment status information, such as using an MM Vehicle Operational Data Gatherer module executing on the vehicle. During and/or after block 484, the routine in block 486 performs further operations to, if vehicle motion causes changes to the vehicle location, further identify additional obstacles (if any) from the environment data for additional locations of the vehicle as it moves and to classify the additional obstacles, and to use specified safety configuration data to determine additional prohibited 3D positions corresponding to the additional obstacles, such as for use during the vehicle motion and/or for additional operations at a final destination of the motion based on next inputs received from a human operator. While not illustrated here, in some embodiments the routine may further take additional fully automated actions after receiving input from a human operator user (whether to change the intended movement/motion corresponding to the input and/or to perform additional tasks after the movement/motion), and/or may further take additional fully automated actions that include providing results of determinations to the human operator to prompt possible changes in future input from the human operator user, such as in a manner similar to that discussed with respect to the fully autonomous operations in blocks 416-462. After blocks 474 or 486, the routine continues to block 488 to determine whether to continue with the semi-autonomous monitoring operations (e.g., until the human operator provides input to indicate that the semi-autonomous monitoring operations are done), and if so returns to block 468 to wait for additional human input. Otherwise, the routine returns at block 499.

FIG. 5 is an example flow diagram of an illustrated embodiment of an EMVAOC Action Determiner module routine 500. The routine may be provided by, for example, execution of an embodiment of module 142 of FIGS. 1A-1B and/or as discussed with respect to FIGS. 2I-2K and elsewhere herein, such as to perform a computer-implemented method to generate and evaluate multiple candidate action sequences for implementing a portion of a task having one or more associated target trajectories and to select one of the action sequences to implement based on the evaluation, or to otherwise predict effects of one or more inputs to vehicle controls. The routine 500 may be invoked in various manners, including in blocks 417 and/or 470 of routine 400 as discussed in FIGS. 4A-4B, and if so may return to its invocation location after the routine returns. While routine 500 is discussed with respect to operations of a single powered earth-moving vehicle at a time, it will be appreciated that the routine 500 may be performed in other manners in other embodiments, including to perform the illustrated activities for multiple powered earth-moving vehicles of the same type and/or multiple types on one or more job sites, whether consecutively and/or concurrently, as well as to be implemented by one or more configured devices and/or computing systems (optionally in multiple locations and/or operating in a distributed or otherwise coordinated manner).

The routine begins at block 505, where it receives current vehicle and environment status information and information about safety configuration constraints and/or other indicated constraints. In block 510, the routine then retrieves a trained MPC predictive dynamics model (or other trained predictive dynamics model), such as a model already deployed to and stored on a current vehicle. In block 515, the routine then determines whether to proceed to determine automated actions to implement for a current task based on predicted effects of those actions from the trained MPC predictive dynamics model, and if so proceeds to perform blocks 520-530, and otherwise proceeds to block 540. In block 520, the routine receives an indication of target vehicle positioning for a current task (e.g., one or more target trajectories in 3D space for points on the vehicle body and/or other vehicle component parts), and generates a defined quantity of candidate action sequences for the vehicle to perform over a defined timeframe that is a subset of a time period for performing the task in order to implement a corresponding portion of that task, optionally using safety configuration data and/or other constraints to restrict candidate action sequences—as discussed in greater detail elsewhere, the defined quantity may be an amount that enables performance of blocks 520-530 in a real-time or near-real-time manner (e.g., within one or more tenths or one-hundredths or one-thousandths of a second). In block 525, the routine then, for each candidate action sequence, evaluates it, including using the trained predictive dynamics model to predict changes to the state of the vehicle and/or the surrounding environment from performing the actions of the sequence, and to then evaluate each such candidate action sequence based on its degree of match to the target trajectories for the current target task, such as based on differences between a portion of the target trajectories and corresponding predicted trajectories for the one or more points on the vehicle body and/or the vehicle component parts. In at least some embodiments and situations, the predictive dynamics model is trained using a single constant vehicle location and orientation, such as to minimize or eliminate differences in vehicle and environment responses corresponding to different locations on one or more job sites, by mapping the corresponding training data to that single vehicle location and orientation—if so, the routine in block 525 may similarly translate a current vehicle location and orientation to the single vehicle location and orientation before providing the input to the trained predictive dynamics model, and then optionally further translate any predicted effects from the model back to the actual location and orientation of the vehicle before the action is implemented. After the evaluation of the candidate action sequences, the routine in block 530 selects one of the candidate action sequences with the highest evaluation for implementation, and provides that selected candidate action sequence as an output response before proceeding to block 599 to return.

If it is instead determined in block 515 not to determine a sequence of automated actions to implement, the routine continues instead to block 540 to determine whether to determine predicted effects of one or more specified vehicle control inputs, such as for vehicle control inputs performed by a manual operator of the vehicle. If so, the routine continues to block 545 to receive one or more indications of the one or more vehicle control inputs, and uses the trained predictive dynamics model to predict changes from the control inputs to the state of the vehicle and/or its surrounding environment (e.g., in a manner independent of the vehicle's actual on-site pose, such as discussed with respect to block 525), as well as optionally performs one or more defined error checks based on safety configuration data and/or other constraints. In block 550, the routine then provides the predicted changes, along with indications of any problems identified from the error checks, and proceeds to block 599 and returns.

If it is instead determined in block 540 not to determine predicted effects of one or more specified vehicle control inputs, the routine continues instead to block 590 to perform one or more other indicated operations as appropriate. Such other indicated operations may include, for example, receiving and storing a trained predictive dynamics model for later use (e.g., a trained MPC predictive vehicle behavior and environment dynamics model), receiving and storing information about a single vehicle location and orientation to use when providing input to the trained predictive dynamics model, receiving and storing information about error checks to perform, receiving and storing information about safety configuration data and/or other constraints, etc. After block 590, the routine continues to block 599 and returns.

Aspects of the present disclosure are described herein with reference to flowchart illustrations and/or block diagrams of methods, apparatus (systems), and computer program products according to embodiments of the present disclosure. It will be appreciated that each block of the flowchart illustrations and/or block diagrams, and combinations of blocks in the flowchart illustrations and/or block diagrams, can be implemented by computer readable program instructions. It will be further appreciated that in some implementations the functionality provided by the routines discussed above may be provided in alternative ways, such as being split among more routines or consolidated into fewer routines. Similarly, in some implementations illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other implementations the operations may be performed in other orders and in other manners. Any data structures discussed above may also be structured in different manners, such as by having a single data structure split into multiple data structures and/or by having multiple data structures consolidated into a single data structure. Similarly, in some implementations illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited therein. In addition, while certain aspects of the invention may be presented in certain claim forms at certain times, the inventors contemplate the various aspects of the invention in any available claim form.

What is claimed is:

1. A computer-implemented method comprising:
obtaining, by a computing device on an earth-moving vehicle on a site that has a body and movable vehicle components including one or more hydraulic arms and at least one tool attachment, a trained model predictive control (MPC) vehicle behavior and environment dynamics model specific to a type of the earth-moving vehicle, the MPC vehicle behavior and environment dynamics model encoding information about movements of the body and the vehicle components of the earth-moving vehicle in response to inputs to physical controls of the earth-moving vehicle; and
initiating, by the computing device on the earth-moving vehicle and using the trained MPC vehicle behavior and environment dynamics model, autonomous operations on the earth-moving vehicle on the site, including:
obtaining, by the computing device on the earth-moving vehicle, one or more target trajectories in three-dimensional (3D) space of the site for target movements of the body and the vehicle components over a period of time to perform a task;
obtaining, by the computing device on the earth-moving vehicle, current vehicle information about positioning of the body and the vehicle components of the earth-moving vehicle in the 3D space on the site from one or more first sensors on the earth-moving vehicle, and current environment information about surfaces of at least some of an area of the site around the earth-moving vehicle from one or more second sensors on the earth-moving vehicle;
determining, by the computing device on the earth-moving vehicle, a plurality of alternative candidate action sequences to perform over at least some of the period of time to cause at least some of the target movements of the body and the vehicle components for the one or more target trajectories, each alternative candidate action sequence including a distinct sequence of multiple actions with associated inputs to apply to the physical controls of the earth-moving vehicle over the at least some of the period of time;
determining, by the computing device on the earth-moving vehicle, one candidate action sequence of the plurality of alternative candidate action sequences to implement on the earth-moving vehicle, including:
using, by the computing device on the earth-moving vehicle and for each of the plurality of alternative candidate action sequences, the trained MPC vehicle behavior and environment dynamics model to predict movements of the body and the vehicle components for the at least some of the period of time from applying the associated inputs for the distinct sequence of multiple actions for that alternative candidate action sequence to the physical controls of the earth-moving vehicle in light of the current vehicle information;
evaluating, by the computing device on the earth-moving vehicle and for each of the plurality of alternative candidate action sequences, a degree of match of the predicted movements of the body and the vehicle components for the at least some of the period of time to some or all of the target movements that correspond to the at least some of the period of time, including determining differences between those predicted movements and the some or all target movements using one or more defined metrics, and wherein the evaluating includes reducing the degree of match as the differences increase; and
selecting, by the computing device on the earth-moving vehicle, the one candidate action sequence based at least in part on the evaluated degree of match for that one candidate action sequence; and
implementing, by the computing device on the earth-moving vehicle, at least one action of the one candidate action sequence on the earth-moving vehicle by applying at least one of the associated inputs for the at least one action to the physical controls of the earth-moving vehicle.

2. The computer-implemented method of claim 1 wherein the implementing of the at least some of the selected one candidate action sequence on the earth-moving vehicle includes implementing a first of the multiple actions for the selected one candidate action sequence,
and wherein the method further comprises performing, for each of one or more additional subsets of the period of time and for corresponding additional portions of the target movements of the body and the vehicle components, the obtaining of the current vehicle information and the current environment information, and the determining of the plurality of alternative candidate action sequences, and the determining of the one candidate action sequence, and the implementing of the at least some of the one candidate action sequence for that additional subset of the period of time.

3. The computer-implemented method of claim 1 wherein the at least some of the period of time for the selected one candidate action sequence is a first length of time that is a subset of the period of time,
wherein the at least some target movements for the selected one candidate action sequence are a first subset of the target movements of the body and the vehicle components over the period of time,
wherein the implementing of the at least some of the selected one candidate action sequence on the earth-moving vehicle includes implementing all of the multiple actions for the selected one candidate action sequence,
and wherein the method further comprises performing, for each of one or more additional subsets of the period of time and for corresponding additional second subsets of the target movements of the body and the vehicle components, the obtaining of the current vehicle information and the current environment information, and the determining of the plurality of alternative candidate action sequences, and the determining of the one candidate action sequence, and the implementing of the at least some of the one candidate action sequence for that additional subset of the period of time.

4. The computer-implemented method of claim 1 wherein the one or more target trajectories include a first target trajectory for the body and further includes one or more second target trajectories for each of one or more of the vehicle components, wherein the evaluating of the degree of match for each of the plurality of alternative candidate action sequences includes using a combination of multiple defined metrics, wherein a first metric of the multiple defined metrics is based on a difference in position of the body between the predicted movements for that candidate action sequence and the some or all target movements, wherein a second metric of the multiple defined metrics is based on a difference in orientation of the body between the predicted movements for that candidate action sequence and the some or all target movements, and wherein one or more third metrics of the multiple defined metrics are each based on a difference in position of one of the vehicle components between the predicted movements for that candidate action sequence and the some or all target movements.

5. The computer-implemented method of claim 1 wherein the MPC vehicle behavior and environment dynamics model further encodes information about changes to 3D surfaces of the area of the site around the earth-moving vehicle resulting from movements of the body and the vehicle components of the earth-moving vehicle in response to inputs to the physical controls of the earth-moving vehicle, and wherein the determining of the differences between the some or all target movements and the predicted movements for an alternative candidate action sequence includes determining differences between target changes to the 3D surfaces of the area of the site from the target movements and predicted changes to the 3D surfaces of the area of the site from the trained MPC vehicle behavior and environment dynamics model.

6. The computer-implemented method of claim 1 wherein the evaluating of the degree of match for each of the plurality of alternative candidate action sequences includes using one or more types of safety constraints to be satisfied as one or more additional defined metrics, including reducing the degree of match for an alternative candidate action sequence for each of the one or more types of safety constraints that is not satisfied for that alternative candidate action sequence.

7. The computer-implemented method of claim 1 wherein the determining of the plurality of alternative candidate action sequences includes eliminating one or more other alternative candidate action sequences from further consideration due to not satisfying one or more types of safety constraints.

8. The computer-implemented method of claim 1 wherein the determining of the plurality of alternative candidate action sequences includes using a trained generative machine learning model to generate one or more likely next actions given the current vehicle information.

9. The computer-implemented method of claim 1 wherein the earth-moving vehicle has multiple physical controls that permit a plurality of inputs, and wherein the determining of the plurality of alternative candidate action sequences includes eliminating, from availability for use in the plurality of alternative candidate action sequences, one or more of the plurality of inputs for one or more of the multiple vehicle controls due to inconsistency of effects of those one or more inputs with the one or more target trajectories.

10. The computer-implemented method of claim 1 wherein the MPC vehicle behavior and environment dynamics model is trained using a single vehicle position and orientation for all training examples, and wherein the using of the trained MPC vehicle behavior and environment dynamics model to predict movements of the body and the vehicle components for each of the plurality of alternative candidate action sequences includes translating current vehicle position and orientation from the current vehicle information to the single vehicle position and orientation before predicting of the movements to cause the predicted movements to be relative to the single vehicle position and orientation, and further translating the predicted movements after the predicting to be relative to the current vehicle position and orientation.

11. The computer-implemented method of claim 1 further comprising, after the autonomous operations are completed, initiating automated monitoring of manual operations of the earth-moving vehicle, including:
receiving, by the computing device on the earth-moving vehicle, further inputs supplied by at least one human operator to the physical controls of the earth-moving vehicle for performing at least one further task;
using, by the computing device on the earth-moving vehicle, the trained MPC vehicle behavior and environment dynamics model to predict further movements of the body and the vehicle components from applying the further inputs to the physical controls of the earth-moving vehicle in light of current vehicle information;
determining, by the computing device on the earth-moving vehicle, that the predicted further movements do not satisfy one or more defined safety constraints; and
initiating, by the computing device on the earth-moving vehicle and in response to the determining that the predicted further movements do not satisfy the one or more defined safety constraints, one or more actions to reduce effects of applying the further inputs to the physical controls.

12. The computer-implemented method of claim 1 wherein the earth-moving vehicle has a vehicle type that is one of an excavator or a bulldozer, wherein the obtaining of the current environment information includes gathering and using data from at least one of one or more LiDAR sensors on the earth-moving vehicle or one or more image sensors on the earth-moving vehicle, wherein the obtaining of the current vehicle information includes gathering and using data from at least one of one or more GPS sensors on the body of the earth-moving vehicle or one or more inclinometer sensors on one or more of the vehicle components of the earth-moving vehicle or one or more pressure sensors on at least one of the vehicle components of the earth-moving vehicle, and wherein the determining of the plurality of alternative candidate action sequences and the determining of the one candidate action sequence and the implementing of a first action of the at least some of the one candidate action sequence on the earth-moving vehicle are performed in a real-time manner in less than 1 second.

13. A system, comprising:
one or more first sensors mounted on an earth-moving vehicle on a site to obtain environment data about an area of the site around the earth-moving vehicle, including at least one of one or more LiDAR sensors, or one or more image capture devices, the earth-moving vehicle having a body and having movable vehicle components and having physical controls for manipulating the movable vehicle components;
one or more second sensors mounted on the earth-moving vehicle to obtain vehicle information about the earth-moving vehicle, including at least one of one or more GPS antennas on a cabin of the earth-moving vehicle, or one or more inclinometers mounted on movable components of the earth-moving vehicle; and
a computing device on the earth-moving vehicle having one or more hardware processors and one or more memories, wherein the one or more memories have a trained vehicle dynamics model that encodes information about movements of the vehicle components of the earth-moving vehicle in response to inputs to the physical controls of the earth-moving vehicle, and wherein the one or more memories further have software instructions that, when executed by the one or more hardware processors, cause the computing device to perform automated operations that provide autonomous operations of the earth-moving vehicle on the site, including at least:
obtaining one or more target trajectories for target movements of the vehicle components over a period of time to perform a task;
determining a plurality of candidate action sequences to perform over at least some of the period of time to cause at least some of the target movements of the vehicle components for the one or more target trajectories, each candidate action sequence including a distinct sequence of multiple actions with inputs to apply to the physical controls of the earth-moving vehicle over the at least some of the period of time;
determining one candidate action sequence of the plurality of candidate action sequences to implement on the earth-moving vehicle, including:
using, for each of the plurality of candidate action sequences, the trained vehicle dynamics model to predict movements of the vehicle components for the at least some of the period of time from applying the distinct set of inputs for that candidate action sequence to the physical controls of the earth-moving vehicle in light of information from the one or more first sensors and the one or more second sensors;
generating an evaluation of each of the plurality of candidate action sequences based at least in part on differences between some or all of the target movements and the predicted movements of the vehicle components for the at least some of the period of time for that candidate action sequence; and
selecting the one candidate action sequence based at least in part on the generated evaluation for that one candidate action sequence; and
implementing at least some of the one candidate action sequence on the earth-moving vehicle by applying at least some of distinct set of inputs for the one candidate action sequence to the physical controls of the earth-moving vehicle.

14. The system of claim 13 further comprising the earth-moving vehicle, and wherein the trained vehicle dynamics model is a model predictive control (MPC) model specific to a type of the earth-moving vehicle, wherein the one or more target trajectories are specified in three-dimensional (3D) space of the area of the site, wherein the obtained environment data includes a 3D mapping of surfaces of at least some of the area of the site, and wherein the determining of the plurality of candidate action sequences and the determining of the one candidate action sequence and the implementing of a first action of the at least some of the one candidate action sequence on the earth-moving vehicle are performed in a real-time manner.

15. The system of claim 13 wherein the trained vehicle dynamics model further encodes information about motion of the body of the earth-moving vehicle in response to inputs to the physical controls of the earth-moving vehicle, wherein the one or more target trajectories include a first target trajectory for the body and further includes one or more second target trajectories for each of one or more of the vehicle components, wherein the generating of the evaluation of each of the plurality of candidate action sequences includes using a combination of multiple defined metrics, wherein a first metric of the multiple defined metrics is based on a difference in position of the body between the some or all target movements and further predicted movements for that candidate action sequence of the body, wherein a second metric of the multiple defined metrics is based on a difference in orientation of the body between the further predicted movements for that candidate action sequence and the some or all target movements, and wherein one or more third metrics of the multiple defined metrics are each based on a difference in position of one of the vehicle components between the predicted movements for that candidate action sequence and the some or all target movements.

16. The system of claim 13 wherein the vehicle dynamics model further encodes information about changes to three-dimensional (3D) surfaces of the area of the site around the earth-moving vehicle resulting from movements of the vehicle components of the earth-moving vehicle in response to inputs to the physical controls of the earth-moving vehicle, and wherein the generating of the evaluation of each of the plurality of candidate action sequences includes determining at least some of the differences between the some or all target movements and the predicted movements for a candidate action sequence by determining differences between target changes to the 3D surfaces of the area of the site from the target movements and predicted changes to the 3D surfaces of the area of the site from the trained vehicle dynamics model.

17. A non-transitory computer-readable medium having stored contents that cause a computing device to perform automated operations, the computing device situated on an earth-moving vehicle on a site that has a body and movable vehicle components, and the automated operations including at least:
obtaining, by the computing device on the earth-moving vehicle on the site, a trained model predictive control (MPC) vehicle dynamics model that encodes information about movements of the body and the vehicle components in response to inputs to physical controls of the earth-moving vehicle; and
receiving, by the computing device on the earth-moving vehicle, inputs supplied by at least one human operator to the physical controls of the earth-moving vehicle for performing at least one task;
using, by the computing device on the earth-moving vehicle, the trained MPC vehicle dynamics model to predict movements of the body and the vehicle components from applying the inputs to the physical controls of the earth-moving vehicle in light of current vehicle information;
determining, by the computing device on the earth-moving vehicle, that the predicted movements do not satisfy one or more defined safety constraints; and
initiating, by the computing device on the earth-moving vehicle, one or more actions to reduce effects of applying the inputs to the physical controls.

18. The non-transitory computer-readable medium of claim 17 wherein the stored contents include software instructions that, when executed by the computing device, cause the computing device to perform further automated operations including at least:
obtaining, by the computing device on the earth-moving vehicle and before the receiving of the inputs, one or more target trajectories in three-dimensional (3D) space of the site for target movements of the body and the vehicle components over a period of time to perform a task; and
determining, by the computing device on the earth-moving vehicle, that the predicted movements of the body and the vehicle components from applying the inputs to the physical controls differ from the one or more target trajectories by at least a threshold amount,
and wherein the initiating of the one or more actions is performed in response to at least one of the determining that the predicted movements do not satisfy the one or more defined safety constraints or the determining that the predicted movements differ from the one or more target trajectories by at least the threshold amount, and includes at least one of applying one or more further inputs to at least one physical control of the earth-moving vehicle, or of blocking transmission of the applied inputs to the physical controls of the earth-moving vehicle, or of alerting the human operator.

19. The non-transitory computer-readable medium of claim 17 wherein the trained MPC vehicle dynamics model is specific to a type of the earth-moving vehicle, and wherein the automated operations further include:
obtaining, by the computing device on the earth-moving vehicle, the current vehicle information from one or more first sensors on the earth-moving vehicle that indicate positioning of the body and the vehicle components of the earth-moving vehicle in three-dimensional (3D) space on the site, and current environment information from one or more second sensors on the earth-moving vehicle about surfaces of at least some of an area of the site around the earth-moving vehicle,
and wherein predicting by the trained MPC vehicle dynamics model of the movements of the body and the vehicle components is further performed in light of the current environment information.

20. The non-transitory computer-readable medium of claim 17 wherein the automated operations further include initiating, by the computing device on the earth-moving vehicle and using the trained MPC vehicle dynamics model, autonomous operations on the earth-moving vehicle on the site, including:
obtaining, by the computing device on the earth-moving vehicle, one or more target trajectories in three-dimensional (3D) space on the site for target movements of the body and the vehicle components over a period of time to perform a task;
determining, by the computing device on the earth-moving vehicle, a plurality of alternative candidate action sequences to perform over at least some of the period of time to cause at least some of the target movements of the body and the vehicle components for the one or more target trajectories, each alternative candidate action sequence including a distinct sequence of multiple actions with associated inputs to apply to the physical controls of the earth-moving vehicle over the at least some of the period of time;
determining, by the computing device on the earth-moving vehicle, one candidate action sequence of the plurality of alternative candidate action sequences to implement on the earth-moving vehicle, including:
using, by the computing device on the earth-moving vehicle and for each of the plurality of alternative candidate action sequences, the trained MPC vehicle dynamics model to predict movements of the body and the vehicle components for the at least some of the period of time from applying the associated inputs for the distinct sequence of multiple actions for that alternative candidate action sequence to the physical controls of the earth-moving vehicle in light of the current vehicle information;
evaluating, by the computing device on the earth-moving vehicle and for each of the plurality of alternative candidate action sequences, a degree of match of the predicted movements of the body and the vehicle components for the at least some of the period of time to some or all of the target movements that correspond to the at least some of the period of time, including determining differences between those predicted movements and the some or all target movements using one or more defined metrics, and wherein the evaluating includes reducing the degree of match as the differences increase; and
selecting, by the computing device on the earth-moving vehicle, the one candidate action sequence based at least in part on the evaluated degree of match for that one candidate action sequence; and
implementing, by the computing device on the earth-moving vehicle, at least one action of the one candidate action sequence on the earth-moving vehicle by applying at least one of the associated inputs for the at least one action to the physical controls of the earth-moving vehicle.
